(19) United States
(12) Patent Application Publication
(10) Pub. No.: US 2016/0267382 A1
(43) Pub. Date: Sep. 15, 2016

(54) METHODS AND DEVICES FOR ANALYSIS OF DIGITAL COLOR IMAGES AND METHODS OF APPLYING COLOR IMAGE ANALYSIS

(71) Applicant: Entertainment Experience LLC, Reno, NV (US)

(72) Inventor: James R. SULLIVAN, St. Augustine, FL (US)

(73) Assignee: Entertainment Experience LLC, Reno, NV (US)

(21) Appl. No.: 14/994,522

(22) Filed: Jan. 13, 2016

Related U.S. Application Data
(60) Provisional application No. 62/103,196, filed on Jan. 14, 2015.

(51) Int. Cl. G06N 5/02; G06T 7/40; G06T 7/00

(52) U.S. Cl. CPC G06N 5/022; G06T 7/0022; G06T 7/408; G06T 2207/10024; G06T 2207/20076; G06T 2207/10016

(57) ABSTRACT

A method of analyzing a color image is disclosed. The color image depicts subject matter of particular interest and/or relevant to solving a given problem. The color image is comprised of image pixels comprising image pixel data. The method is comprised of storing hypothesis decision output information in multi-dimensional color look-up tables; for each pixel of the color image, using the multi-dimensional color look-up tables to produce logic decision output information; grouping the logic decision output information statistically to produce logic decision output information; combining logic decision output information into statistical hypothesis decisions for the color image; and applying the statistical hypothesis decisions to perform an action on the subject matter of the image directed to produce a decision regarding the problem of interest. The problem of interest may be a medical, space or oceanographic exploration, intelligence, forensic, counterfeiting, agricultural, meteorological, seismological, or object detection problem.

### CROSS-REFERENCE TO RELATED PATENT APPLICATIONS

This application claims priority to U.S. provisional patent Application No. 62/103,196 filed Jan. 14, 2015, the disclosure of which is incorporated herein by reference. This application is also related to commonly owned U.S. patent application Ser. No. 12/869,624, now U.S. Pat. No. 8,520,023; U.S. patent application Ser. No. 13/957,907, now U.S. Pat. No. 8,767,006; and U.S. patent application Ser. No. 13/692,066, now U.S. Pat. No. 8,860,751, the disclosures of which are incorporated herein by reference.

### BACKGROUND

1. Technical Field

Methods of and devices for analyzing digital color images, and in particular, methods and devices for analyzing digital color images, and making analysis-based decisions, in lieu of visual inspection by a human. Additionally, methods of performing an action to solve a problem, the problem solving action based upon the analysis of digital color images performed according to the image analysis methods disclosed herein.

2. Description of Related Art

Visual inspection is a widely used method to determine the current state of objects in many commercial markets, as well as in scientific research and public sector activities that are carried out in the public interest. Commercial market examples include visual inspection in blood and tissue health, crop and animal health, consumer product quality, and energy and resource exploration. Scientific research and public sector activities include those pertaining to environmental safety, space and oceanographic exploration, law enforcement, and military, intelligence, and other national security operations.

Humans can be trained to make detailed determinations from images and videos to assist in all of these markets and applications. A key physical characteristic of these determinations is often the color of objects in the images or videos. Healthy tissue and blood have specific colors, as do healthy crops and bodies of water. Consumer product quality is often related to the color of the product such as an automobile or article of clothing. Resource and space and ocean exploration use pseudo-color to record data for material density, energy, speed, distance and other physical characteristics in order to make real time decisions. Military and intelligence applications use different imaging modalities such as infrared, radar, mapping, and aerial to assess enemy positions, supplies, and strength for security-related decisions.

Currently, certain specific color image analysis methods, such as Iterative Transform Divergence (ITD), are used to analyze images in an attempt to outperform visual analysis. Such methods are computer intensive with applications limited to constrained image analyses such as automated signature recognition. They produce results that do not match visual results, and are not acceptable for critical analyses such as medical diagnosis aids or energy exploration or military and intelligence applications. They are not able to match human analysis for more saturated colors that are lost in the processed sensor data.

With regard to medical imaging, certain methods use Independent Component Analysis (ICA), and multiple image channels to conduct automated analysis of medical images. These methods are computer intensive, and do not use the commonly available graphics functions of computers or mobile displays. Thus they are slow and limited in performance speed. They also use image feature sets and are not designed to match visual analyses; thus they may produce hypothesis testing differences from human vision, with features found that are not visually critical, while also missing features that are visually critical. To the best of the Applicants' knowledge, they also do not use color vision models, and they do not use raw, unprocessed image or video data and thus will not be able to match human analysis for more saturated colors or high intensity range information in scenes due to that data being lost in sensor data processed to current display standards.

Also with regard to medical imaging, color change analysis of medical tissue images including color calibration has been performed. To the best of the Applicants' knowledge, such methods do not include using visual models that would accurately match visual inspection in any viewing lights or use a visual color model to accurately determine visual color differences, nor do such methods use graphics shaders and trained multi-dimensional tables to produce a visual analysis match for speed and implementation across all computers and mobile displays. Additionally, such methods will likely be difficult and costly to implement, and also be slow to produce results, thus reducing the value to automatic analyses that target fast aids to human diagnosis. Such methods also do not describe using raw, unprocessed image or video data and will not be able to match human analysis for more saturated colors or high intensity range information in scenes due to that data being lost in sensor data processed to current display standards. The color calibration of such methods does not preserve this lost color and intensity information that is available in raw sensor data and in human vision, but not in processed sensor data.

With regard to communication devices used for imaging, cell phone sensors for image improvement and analysis have been disclosed, including unique processing modules for viewing and analysis in two processing paths linked to a cell phone sensor. Related methods for image improvement include one of white point adjustment, gamma correction, edge enhancement, or image compression optimization; and specific methods of image analysis that include one of edge detection, pattern analysis, texture classification, or Fourier-Mellin (FM) image transforms, Scale-Invariant Feature Transform (SIFT), or Speeded Up Robust Features (SURF). To the best of the Applicants' knowledge, visual or color models are not known in either image improvement or analysis, nor are the use of fast graphics shaders or multi-dimensional look-up-tables that have been trained to match visual analyses. Such methods will be difficult to implement on a cell phone and slow to process the image or video data, thus delaying the results to aid human diagnosis in any medical imaging application. Such methods also do not use direct sensor color data that has not been processed in order to reduce scene differences for display standards. Thus such methods will not be able to match human analysis for more saturated colors that are lost in the processed sensor data.

In summary, analysis of images by humans continues to be essential in these commercial fields because of the many problems that remain unsolved in automated image analysis. However, such human analysis can be costly, with significant training and labor hours required. Such training is of necessity very specific to the problem being addressed by the image analysis. The effectiveness of image analysis by humans is also reduced by variations among observers and observer fatigue. What is needed are automated methods of image analysis that are reliable, high in accuracy, and of low cost.

### SUMMARY

The present invention meets this need by providing methods of analyzing digital color images and making analysis-based decisions; and additionally, methods of performing an action to solve a problem, the problem solving action based upon the analysis of digital color images performed according to the image analysis methods. In certain embodiments, the image analysis methods may be used in lieu of visual inspection by a human, and a human-generated decision.

In a broad aspect of the invention, a computer implemented method is provided, which may be in lieu of human visual inspection and decision making, in which an image is analyzed, and a decision is generated based upon the analysis of the image. The decision may subsequently be put into action, i.e., an action is taken on the subject matter of the image, or related to the subject matter of the image. The action may be directed to solving a problem related to the subject matter of the image.

In general, the analysis of the image is preceded by an analysis of a problem that may be addressed using image analysis. Decisions that may be made to solve the problem, or otherwise address the problem such as acting on an opportunity resulting from the existence of the problem, are identified and decision criteria and/or specifications are defined. The decision criteria and/or specifications are translated into decision making information, including hypothesis decision output information. In one aspect of the invention, the hypothesis decision output information is stored in multi-dimensional color look-up tables. The multi-dimensional color look-up tables may be used to analyze an image or a plurality of images, such as a video or movie. Subsequently, a decision may be generated, and an action taken as described above. The image analysis is performed by a computer. The decision generation may also be performed by the computer. The action may also be implemented and controlled by the computer. In that manner, human analysis, decision generation, and action may be replaced or augmented using the methods of the present disclosure.

The methods of the present disclosure are applicable to a variety of fields, including but not limited to oil and gas exploration, diagnostic imaging in health care, agriculture, environmental protection, space weather and space exploration, oceanographic exploration, public safety, financial transactions, military operations, homeland security, and anti-counterfeiting of consumer products, currency, and other government and private sector financial documents. In general, the instant methods are applicable and particularly advantageous in applications in which color images and/or real-time color displays must be analyzed and/or visually inspected by humans, and judgments and/or decisions made based on the images and/or displays. Applications in which ongoing visual inspections of large numbers of images by a human are particularly suited to the methods of the present disclosure. When a human must perform repeated visual inspections of images or display and render judgments or decisions based upon each image, such a task requires not only a high level of training as to how to render the judgment/decision, but also a continuously high level of concentration throughout the entire series of image/display inspections. It is well known that as the number of images to be inspected by a human increases, the error rate in judgments/decisions also increases, due to an increase in physical and mental fatigue and a decrease in attention span that occurs. Additionally, there is also a variation in judgment and decision making across a range of human observers that will be present and is unavoidable.

In another aspect of the invention, a method of color image analysis is provided in which visual matching that would otherwise be done via analysis by humans is instead done automatically using an image processor. In the method, the visual matching is done using standard graphics functions, shaders or multi-dimensional look-up tables that are optimized for speed on any computer or mobile display device. In another aspect of the invention, color and monochrome vision models are used in the construction and training of three-dimensional look-up tables to have the highest accuracy match to the vision analysis done by humans in any viewing lights. In another aspect of the invention, raw unprocessed digital image data from a digital camera is used to maintain full color accuracy within scenes. In that manner, color and scene range information that is visible to humans is fully maintained in an image, rather than being “clipped,” i.e. lost when conventional camera sensor data is processed within the camera according to image display standards.

More specifically, in accordance with the present disclosure, there is provided a method of analyzing a color image. The color image depicts subject matter of particular interest and/or relevant to solving a given problem and/or acting on an opportunity resulting from the existence of the problem. The color image is comprised of image pixels comprising image pixel data. The color image is embodied as a digital image and may be stored on a computer readable storage medium, such as a memory, a hard disk drive, or a CD OR DVD ROM. The method is comprised of storing hypothesis decision output information in multi-dimensional color look-up tables; for each pixel of the color image, using the multi-dimensional color look-up tables to produce logic decision output information; combining logic decision output information into statistical hypothesis decisions for the color image; and applying the statistical hypothesis decisions to perform an action on the subject matter of the image directed to produce a decision regarding the problem of interest.

The method may be further comprised of sectioning the color image into regions of selectable and adaptable size and shape, grouping the logic decision output information in each image region statistically to produce logic decision output information for each image region, and combining logic decision output information from multiple regions into statistical hypothesis decisions for the color image.

The method may further include revising the hypothesis decisions for the images using an image capture specific parameter. The image capture specific parameter may be selected from resolution, angle, and zoom. The method may further include storing a record of the hypothesis decisions.

In certain embodiments, the multi-dimensional look-up tables may be defined using a non-RGB color space that includes a transformation to a visual color space. The transformation may better define visual color differentiation of the color image. The visual color space may be, e.g., CIE IPT color space or the CIECam02 color space.

Alternatively or additionally, the logic decision output information produced from the multi-dimensional look-up tables may be defined using unprocessed data from digital sensors, and/or image data from multiple images captured at different exposure levels, and/or image data from multiple frames of video sequences, including joint hypothesis decisions from the sequences. By using multiple images captured at different exposure levels, the dynamic range of the image pixel data of the color image is provided with extended intensity.

In certain embodiments, the multi-dimensional look-up tables may be nested multi-dimensional look-up tables. The nested multi-dimensional look-up tables may use high speed graphics shader processing to produce the hypothesis decisions at the high processing speeds. The nested, multi-dimensional look-up tables and hypothesis decisions may be defined using raw digital camera data, in which case, no color or range processing is needed, as is the case for current displays.

The nested, multi-dimensional look-up tables and hypothesis decision output information may be defined using multiple images captured at different exposure levels. In such circumstances, the highest dynamic range of capture data for the most accurate hypothesis decisions is achieved. The images may be multiple still images or a chronological sequence of captured images such as from a video or movie. The nested multi-dimensional tables may be implemented in mobile devices that include digital image or video capture to allow for complete capture to hypothesis decisions for mobile use in all applications.

In certain embodiments, the method may further comprise communicating a summary of hypothesis decisions to a human user using at least one of a visual display, an audible signal, and a tactile stimulator. The hypothesis decisions for each region of the image may be communicated visually for further human analysis. A subset of the hypothesis decisions may be chosen for vision decision training of a human user. In such circumstances, at least one of the chosen hypothesis decisions may be chosen by human users and automatically analyzed.

The instant method is not limited to use in analyzing a single color image. In certain applications, the subject matter of particular interest and/or the given problem to be solved are comprised of, or addressed, using multiple images. In such circumstances, the method further comprises providing a plurality of color images, each of the images depicting subject matter pertaining to the problem of interest and comprised of image pixels comprising image pixel data; for each pixel in each of the color images, using the multi-dimensional color look-up tables to produce logic output information; and applying the hypothesis decisions to perform the action on the subject matter of the images directed to produce a decision regarding the problem of interest. The plurality of color images may be comprised of multiple still images, or a chronological sequence of captured images, such as from a video or a movie.

As noted previously, the image analysis methods of the present disclosure are applicable to a variety of problems and events. Accordingly, in a broad aspect of the present disclosure, there is further provided a method of performing an action in advance of an impending event. The method comprises acquiring a color image indicative of the impending event, the color image comprised of image pixels comprising image pixel data; defining decision criteria, including at least one action to be taken if the probability of the impending event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the impending event; combining logic decision output information into statistical hypothesis decisions for the color image, including determining the overall probability of the impending event occurring; and if the overall probability of the event occurring exceeds the threshold value, performing an action in advance of the impending event.

An event may be determined to be impending via the analysis of the image(s) according to the instant methods, or the event may be known to be impending from other information. Exemplary events may include but are not limited to weather, seismic, medical, political, military, or economic events. Economic events, such as changes in supply, demand, and/or pricing of commodities, manufactured goods, and services, may result from military, political, agricultural, and/or energy related events.

In one aspect of the present disclosure, an application of the instant image analysis methods to a meteorological problem is provided. More particularly, a method of performing an action in advance of an impending weather event is provided. The method comprises acquiring a color image indicative of the impending weather event, the color image comprised of image pixels comprising image pixel data; defining decision criteria, including at least one action to be taken if the probability of the impending weather event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the impending weather event; combining logic decision output information into statistical hypothesis decisions for the color image, including determining the overall probability of the impending weather event occurring; and if the overall probability of the impending weather event occurring exceeds the threshold value, performing an action in advance of the impending weather event.

The method may further comprise sectioning the color image into regions, grouping the logic decision output information in each image region statistically to produce logic decision output information for each image region, and combining logic decision output information from multiple regions into the statistical hypothesis decisions.

The action performed in advance of the impending weather event may be to issue a warning of the impending weather event, particularly if the impending weather event is a dangerous event. For example, if the method is directed to analyzing an image or sequence of images to predict tornado formation, the action may be to issue a tornado warning. If the impending weather event is of a longer time scale, the action to be taken may be to perform a financial transaction in a market that may be affected by the impending weather event.

In another aspect of the present disclosure, an application of the instant image analysis methods to a seismic problem is provided. More particularly, a method of performing an action in advance of a seismic event is provided. The method comprises acquiring a color image indicative of the seismic event, the color image comprised of image pixels comprising image pixel data; defining decision criteria, including at least one action to be taken if the probability of the seismic event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the seismic event; combining logic decision output information into statistical hypothesis decisions for the color image, including determining the overall probability of the seismic event occurring; and if the overall probability of the seismic event occurring exceeds the threshold value, performing an action in advance of the seismic event.

In another aspect of the present disclosure, an application of the instant image analysis methods to an agricultural problem is provided. More particularly, a method of performing an action in advance of an agricultural event is provided. The method comprises acquiring a color image indicative of the agricultural event, the color image comprised of image pixels comprising image pixel data; defining decision criteria, including at least one action to be taken if the probability of the agricultural event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the agricultural event; combining logic decision output information into statistical hypothesis decisions for the color image, including determining the overall probability of the agricultural event occurring; and if the overall probability of the agricultural event occurring exceeds the threshold value, performing an action in advance of the agricultural event.

In another aspect of the present disclosure, an application of the instant image analysis methods to an energy problem is provided. More particularly, a method of energy resource development is provided. The method comprises acquiring a color image indicative of an energy source present in a region of the Earth, the color image comprised of image pixels comprising image pixel data; defining decision criteria, including at least one action to be taken if the probability of the subterranean energy source being present exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the energy source being present; combining logic decision output information into statistical hypothesis decisions for the color image, including determining the overall probability of the energy source being present; and if the overall probability of the energy source being present exceeds the threshold value, performing an action in advance of the energy source being developed for use in an energy application.

In another aspect of the present disclosure, an application of the instant image analysis methods to a medical problem is provided. More particularly, a method of treating a medical condition in a patient is provided. The method comprises acquiring a color image indicative of the medical condition, the color image comprised of image pixels comprising image pixel data; defining decision criteria, including at least one action to be taken if the probability of the medical condition being present in the patient exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the medical condition; combining logic decision output information into statistical hypothesis decisions for the color image, including determining the overall probability of the medical condition being present in the patient; and if the overall probability of the medical condition being present in the patient exceeds the threshold value, performing an action including at least one of preventing the medical condition being present in the patient or treating the medical condition in the patient.

In another aspect of the present disclosure, an application of the instant image analysis methods to a counterfeiting problem is provided. More particularly, a method of determining authenticity of an object from by an object source is provided. The method comprises acquiring a color image of the object, the color image comprised of image pixels comprising image pixel data; defining decision criteria, including at least one action to be taken if the probability of the object being counterfeit exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the object being counterfeit; combining logic decision output information into statistical hypothesis decisions for the color image, including determining the overall probability of the object being counterfeit occurring; and if the overall probability of the object being counterfeit exceeds the threshold value, confiscating the object from the object source.

In another aspect of the present disclosure, an application of the instant image analysis methods to a financial problem is provided. More particularly, a method of performing a financial transaction in advance of an expected event is provided. The method comprises acquiring a color image indicative of the expected event, the color image comprised of image pixels comprising image pixel data; defining decision criteria, including at least one action to be taken if the probability of the expected event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the expected event; combining logic decision output information into statistical hypothesis decisions for the color image, including determining the overall probability of the expected event occurring; and if the overall probability of the expected event occurring exceeds the threshold value, concluding the financial transaction in advance of the expected event.

It is to be understood that the above examples, which are described in further detail herein, as well as other examples disclosed herein are to be considered exemplary and not limiting. The methods and devices for performing them may be applied to other problems, including those listed in TABLE 1 and elsewhere in this specification. The actions may be directed to solving a given problem relating to the subject matter of the images to be analyzed, and/or the actions may be directed to acting on an opportunity resulting from the existence of the problem. The actions may be physical in nature, or they may be financial or other business-related actions, i.e., business actions including financial transactions taken in response to the conclusions arrived at by using the instant methods.

In accordance with the present disclosure, there is also provided a device for analyzing a color image depicting subject matter pertaining to a problem of interest and comprised of image pixels comprising image pixel data. The device may be comprised of a processor in communication with a first non-transitory computer readable medium storing an algorithm communicable to and executable by the processor, and including the steps of the method as described above.

In certain embodiments, the device may include a data input port in communication with a source of the color image and in communication with the processor. The source of the color image may be a second non-transitory computer readable medium. Alternatively, the source of the color image may be a digital camera, or a mobile device comprising a digital camera. In certain embodiments, the device itself may be a mobile device comprising a digital camera. The algorithm may include steps for digital image capture including complete image scene range to produce the hypothesis decisions.

The sources of the images to be analyzed by the methods and devices of the present disclosure may vary widely, depending upon the particular application. The images may be obtained from optical and electro-optical imaging systems operable in the ultraviolet, visible, and/or infrared spectrum. such systems may include optical microscopes, conventional cameras, television and movie cameras, and optical telescopes. The images may be obtained from non-optical imaging systems, such as including magnetic resonance (MRI), positron emission tomography (PET), single-photon emission computed tomography (SPECT), computed tomography (CT), UV micro- and telescope, medical thermography, side-scanning radar, or radio-telescope imaging systems. In certain embodiments, the images may be obtained from imaging systems that are set up and dedicated to the purpose of imaging for the particular application. In other embodiments, the images may be sourced from imaging systems that are set up for a range of purposes, including satellite imaging systems, security cameras, and aerial reconnaissance systems. Such imaging systems may be connected to the Internet, with the digital image data accessible by a variety of computing and image analysis devices including personal computers, tablets, and smart phones. In certain embodiments, the images may be “pseudocolor” images, in which digital data having a range of values is represented by a range of colors.

### BRIEF DESCRIPTION OF THE DRAWINGS

The patent or application file contains at least one photograph and one drawing rendered in color. Copies of this patent or patent application publication with color photographs and drawings will be provided by the Office upon request and payment of the necessary fee. A Petition for the acceptance of color photographs and drawings is being filed under 37 CFR 1.84(a)(2) and 37 CFR 1.84(b)(2) concurrently with this application.

The present disclosure will be provided with reference to the following drawings, in which like numerals refer to like elements, and in which:

FIG. 1 is a flow chart depicting a generalized method of solving a problem using image analysis, and including a method of analyzing a color image, in accordance with the present disclosure;

FIG. 2 is a block diagram of a system for analyzing a color image in accordance with the present disclosure;

FIG. 3 is a schematic representation of a multi-dimensional look-up table containing hypothesis decision output information in accordance with a method and a system of the present disclosure;

FIG. 4 is a block diagram of a vision decision method for multiple exposures and multiple frames from videos in accordance with the present disclosure;

FIG. 5 is a grey scale image of an original exemplary pseudo-color image of a localized weather event including a severe storm, which may be analyzed using methods of the present disclosure;

FIGS. 6A and 6B are first and second portions of a flow chart depicting an exemplary application of the methods of the present disclosure to the analysis of a pseudo-color image depicting a localized weather event, such as depicted in FIG. 5, and to providing statistical hypothesis decisions, which may be applied to perform an action in view of the weather event;

FIG. 7 is a monotone representation of an exemplary input image comprised of three regions of color or pseudo-color material density from oil exploration images;

FIG. 8 is an exemplary first output hypothesis test % for hypothesis test T from the regions illustrated in FIG. 7;

FIG. 9 is an exemplary second output hypothesis test % for hypothesis test S from the regions illustrated in FIG. 7;

FIG. 10 is an exemplary aggregated overall decision report regarding the likelihood of the hypotheses tests of FIGS. 8 and 9 being true;

FIG. 11A is a monotone representation of an exemplary input image comprised of three regions of pseudo-color material density from a medical image;

FIG. 11B is an exemplary output hypothesis test depicting regions of probability of tumor from image analysis hypothesis testing of the image of FIG. 11A;

FIG. 12 is a color chart that may be used in defining hypothesis decision output information in an exemplary method of the present disclosure as applied to a medical problem;

FIG. 13 is a is a graph of data of FIG. 12, blood color at various concentrations of methemoglobin, plotted in CieLab color space;

FIG. 14 is a is an exemplary image of internal body tissue in a patient acquired by use of an endoscope, which image may be analyzed using the methods of the present disclosure;

FIG. 15 is a version of the image of FIG. 15 with enhanced colors;

FIG. 16A is a detailed view of a portion of the image of FIG. 14;

FIG. 16B is a detailed view of a portion of the image of FIG. 15; and

FIG. 16C is a detailed view of a portion of the image of FIG. 14 or FIG. 15, with certain colors of the image modified to provide high contrast with surrounding regions.

### DETAILED DESCRIPTION

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

For a general understanding of the present invention, reference is made to the drawings. In the drawings, like reference numerals have been used throughout to designate identical elements. In describing the present invention, a variety of terms are used in the description. Standard terminology is widely used in image processing, display, and projection arts. For example, one may refer to the International Lighting Vocabulary, Commission Internationale de l'éclairage (CIE), 1987 for definitions of standard terms in the fields of color science and imaging. One may also refer to Billmeyer and Saltzman's PRINCIPLES OF COLOR TECHNOLOGY, 3^{RD} Ed, Roy S. Berns, John Wiley & Sons, Inc., 2000; and Color Appearance Models, Mark D. Fairchild, Wiley-IS&T, Chichester, UK (2005).

In order to fully describe the invention, as used in the present disclosure, certain terms are defined as follows:

Color—A specification of a color stimulus in terms of operationally defined values, such as three tristimulus values.

Color Space—An at least three-dimensional space in which each point therein corresponds to a color. A color space may be of higher than three dimensions, such as a four-dimensional color space, e.g., RGBY.

Pseudo-color—A reference to colors in an image that has been defined to represent a range of values of a particular parameter, such as air velocity in an image rendered to represent conditions in a weather event such as a storm. The colors may be defined using tristimulus values.

Video—in reference to images, a plurality of images provided in a sequence, and typically in a chronological sequence. As used herein, not limited to a television video format; a plurality of images referred to herein as a “movie” is also to be considered a “video” as used herein.

RGBCYMW—in the use of any of these capital letters in combination herein, they stand for red, green, blue, cyan, yellow, magenta, and white, respectively.

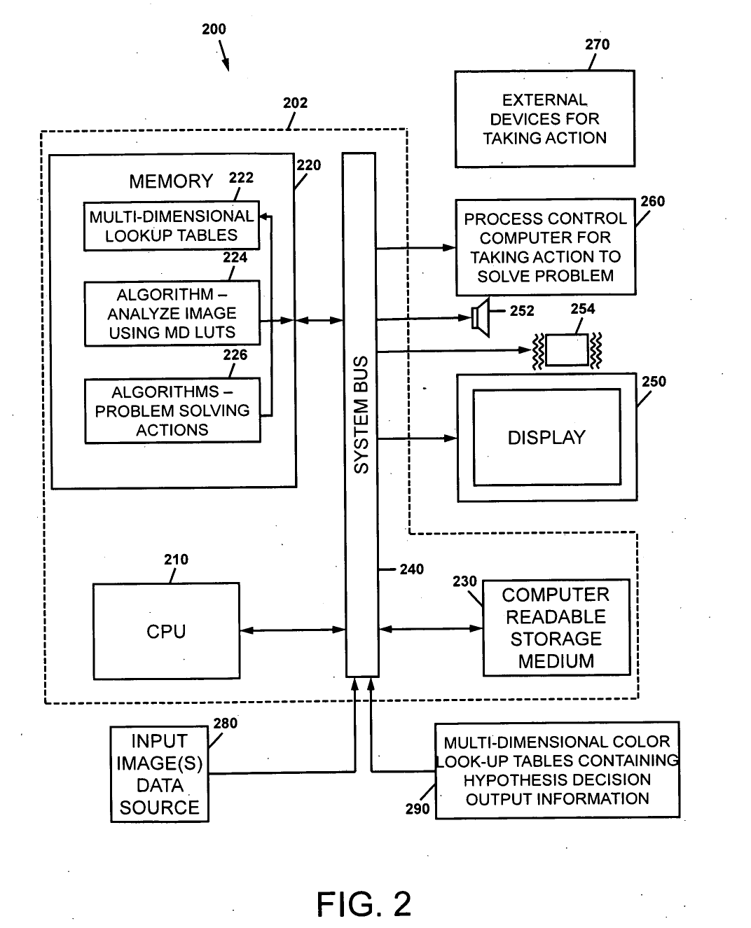

Referring first to FIG. 2, a device for analyzing a color image, and for applying the analysis of the image to solve a given problem and/or act on an opportunity resulting from the existence of the problem, is depicted. Device 200 is comprised of a computer 202, which may include a central processing unit or other processor 210, a memory 220, a computer readable non-transitory storage medium 230, all of which may be in communication through a central system bus 240. The memory 220 may store multi-dimensional look-up tables 222 and executable programs including algorithms 224 to analyze images using the multi-dimensional look-up tables 222 as will be described subsequently. The algorithms 224 are communicable to and executable by the processor 210. The computer 202 may receive input image data to be analyzed through an input data port (not shown) from an input image data source 280, and multi-dimensional look-up tables from a source 290. The input image data and multi-dimensional look-up tables may be stored in the non-transitory storage medium 230 and/or in the memory 220. The input image data and/or multi-dimensional look-up tables may be stored in a second computer readable non-transitory storage medium (not shown). The input image data may be sourced from a camera that captures still images or a sequence of images as a video or movie. In certain embodiments, the device 200 itself may include the camera. In such embodiments, the color image analysis methods disclosed herein may be performed in real time using the device itself. In certain embodiments, the device 200 may be provided as a mobile device, such as a smartphone or tablet computer, which may comprise an image display and may also include an additional processor operable to perform additional functions associated with such devices.

Alternatively, the methods disclosed herein may be performed subsequent to acquisition of an image or multiple images, or in real time wherein the device 200 receives the color image from a separate device that is providing the image. Such separate devices include but are not limited to a separate computer, tablet, smartphone, of a digital camera. The color image(s) may be received via cable or via wireless transmission.

It is to be understood that the architecture of the computer 202 is not limited to that shown in FIG. 2. Other architectures for computer 202 are contemplated. For example, the computer 202 may be an application-specific integrated circuit (ASIC), sometimes also characterized as a system-on-chip (SoC). Such an ASIC 202 may include a microprocessor 210, and memory blocks 220, including ROM, RAM, EEPROM, and/or flash memory; however, the ASIC 202 is not limited to having only such components.

The results of the analysis of images and decisions made to solve the problem may be communicated to a display 260. The computer memory may also contain programs executable by the CPU 210, including algorithms 226 for causing and/or controlling actions taken, based on the analysis of an image or images. Alternatively, the computer 202 may be in communication with a process control computer 260 that contains programs that may be executed to cause and/or control actions taken to solve the problem or act on the opportunity.

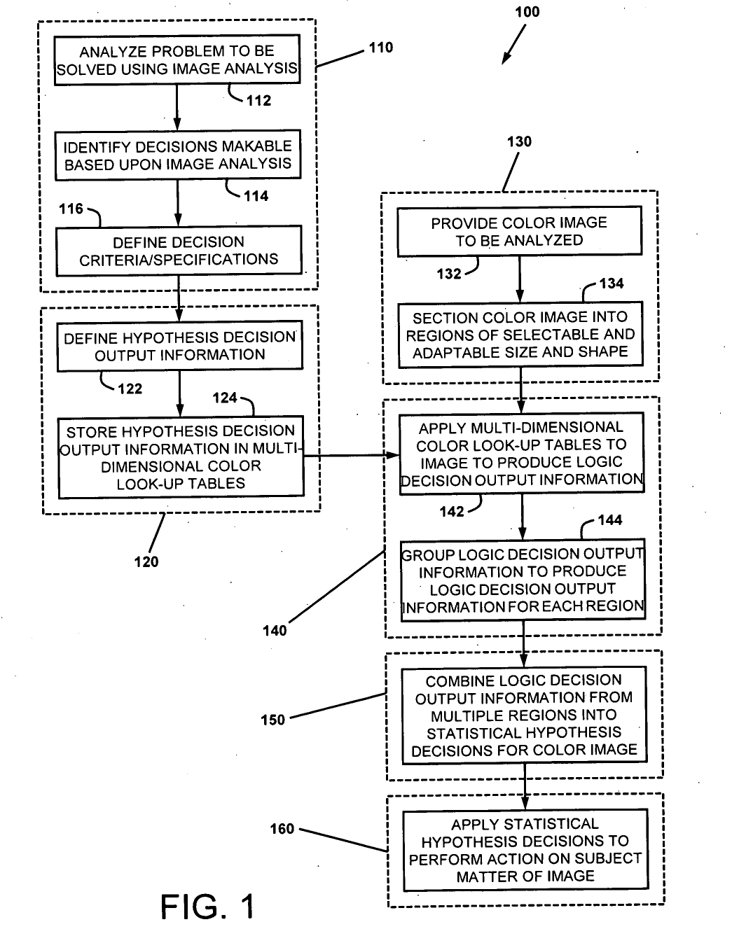

Referring now to FIG. 1, a flow chart is provided, which depicts a generalized method 100 of solving a problem using image analysis, and including a method of analyzing a color image, in accordance with the present disclosure. The generalized method may begin with the realization that a given problem may be solved using image analysis. TABLE 1 is a listing of some examples of problems to which the methods of the present disclosure may be applied. It is to be understood that the listing in TABLE 1 is meant to be exemplary, and not limiting. There are many other problems to which the methods of the present disclosure may be applied. Additionally, the term “problem” is to be construed broadly with regard to FIG. 1 and the present disclosure. A “problem” may be an issue to be addressed that relates directly to the subject matter of the image(s) to be analyzed. Alternatively or additionally, a “problem” to be solved may be directed to acting on an opportunity, i.e., how does one recognizes an opportunity that is identified as a result of the analysis of images according to the instant image analysis methods, and then act on the opportunity.

TABLE 1
Exemplary listing of problems which may be addressed using the methods of the present disclosure.

| | | IMAGES RELATING TO | DECISION/CONCLUSION | |
|---|---|---|---|---|
| GENERAL | | PROBLEM AND AVAILABLE | RESULTING FROM | |
| FIELD | PROBLEM(S) | TO BE ANALYZED | IMAGE ANALYSIS | ACTION |
| Agriculture | Predicting crop yields, | Satellite images | Geographical/national/ | Deploy stored food/surpluses |
| | failures, and famines | | geopolitical crop surpluses | to shortage areas |
| | | | and shortages | Diplomatic actions |
| | | | | Financial actions - e.g., |
| | | | | trading of commodity futures |
| Energy | Selecting “highest | Satellite images | Selection of oil/gas field for | Drill oil/gas wells at selected |
| | odds” oil/gas field | Seismic imaging, e.g., | drilling | site |
| | candidates for drilling | reflection seismology images | Estimate oil and gas | Financial actions - e.g. |
| | | | reserves | trading of commodity futures |
| Medicine | Diagnosing presence or | Diagnostic medical images - | Presence of cancer, heart | Medical intervention as |
| | absence of illness in a | CAT scans, MRIs, etc. | disease, other illness, and | needed |
| | patient | | relative stage | |
| Space weather | Prediction of solar | Space telescope X-ray and | Disruption of radio | Issue warnings to |
| and space | flares | UV images | communications and/or | broadcasters/operators of |
| exploration | Prediction of intensity | Radio telescope images | power grids | wireless communication |
| | of detected solar flares | Optical telescope images | Radiation hazards to | systems and public utilities |
| | | | spacecraft and astronauts | Issue warnings to astronauts |
| | | | | and spacecraft/satellite |
| | | | | operators |
| Oceanographic | Identifying/detecting | Sonar images | Presence of significant | Issue earthquake/tsunami |
| exploration | submerged mantle | | stress areas for possible | warning |
| | plate movement | | earthquakes | |
| Seismology | Unpredictability of | Seismic images | Likelihood of earthquake | Issue earthquake warning |
| | earthquake location | | within defined time window | |
| | and intensity | | | |
| | Magma dynamics: | Seismic images | Likelihood of volcanic | Issue volcanic eruption |
| | Unpredictability of | Surface and atmospheric | eruption within defined time | warning |
| | volcanic eruptions | thermal images | window | |
| | Selecting geothermal | Atmospheric spectroscopic | Selection of “hot zone” for | Build geothermal energy |
| | energy site | images | conversion of geothermal | apparatus at selected site |
| | | | energy | |
| Meteorology | Short term real-time | Doppler radar | Tornado present or | Issue tornado warning |
| | threat assessment (e.g. | Aircraft-acquired images | incipient | |
| | tornado warning) | | | |
| | Long term forecasting | Satellite images | | |
| Military | Enemy troop and asset | Satellite and reconnaissance | Threat present; action | Deploy military |
| operations | deployments | aircraft images | required | assets/personnel |
| Homeland | Terrorist actions | Satellite and reconnaissance | Threat present; action | Deploy law enforcement |
| security | | aircraft images | required | officers |
| | | Conversion of material | Explosive, biohazard, or | As above; evacuate area, |
| | | sensing device (e.g., explosive | other dangerous material | contain and disable and/or |
| | | “sniffers”) data to pseudo- | present; action required | dispose of dangerous |
| | | image data | | material |
| Law | Drug interdiction | Reconnaissance aircraft | UV lighting, traffic patterns, | Deploy law enforcement |
| enforcement | | images | and/or crop growth indicate | officers |
| | | | drug trade likely in progress | |
| Authentication | Counterfeit currency | Color images of currency | Currency in question | Proceed with criminal |
| of objects | | obtained via scanning | confirmed as counterfeit | investigation to ID source |

Once a problem that may be solved using image analysis has been identified, in a first set of steps 110, the problem is analyzed with respect to the opportunity to use image analysis to solve the problem. In a first step 112, the problem is analyzed to determine if images exist or can be acquired, which can be analyzed, thereby providing information that can be directed to a solution of the problem. In step 114, decisions are identified that can be made based upon analysis of an image or images. The decision may be a simple yes/no decision to take a certain action, or a decision to take a particular action to some extent quantitatively. In step 116, decision criteria or specifications are defined. For example, a decision criterion might be, “If image analysis indicates condition X is met, make decision Y,” or “make conclusion Z.”

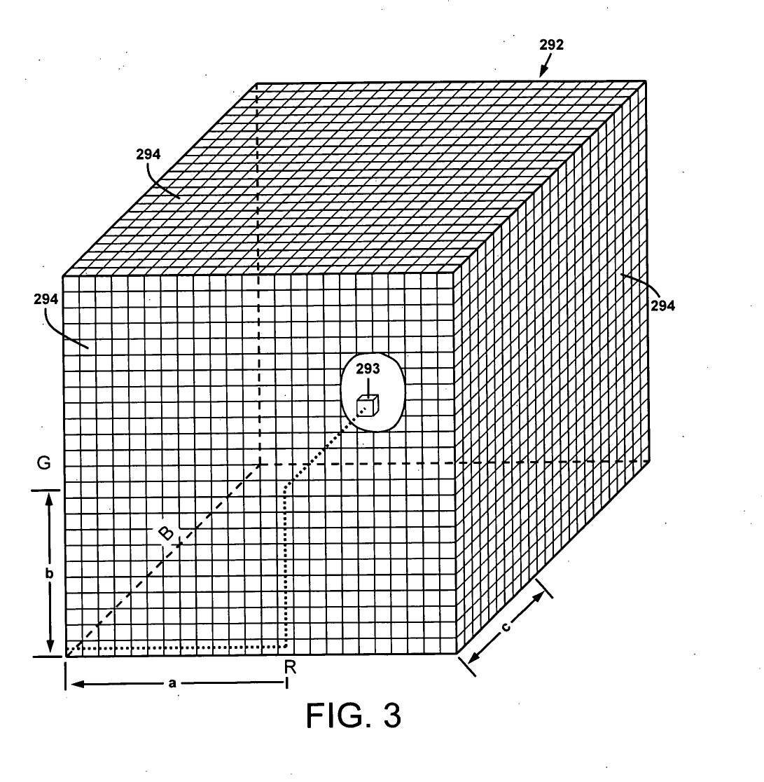

In a set of steps 120, the decision criteria are translated into information that may be loaded into a computer containing a program that, when executed, performs analysis of an image or images. In step 122, hypothesis decision output information is defined. Hypothesis decision output information may be the probability of an event occurring, if a particular value of a parameter occurs; or alternatively, hypothesis decision output information may simply be information on whether something is true or not true. In step 124, the hypothesis decision output information is stored in multi-dimensional color look-up tables 290. FIG. 3 is a schematic representation of an exemplary multi-dimensional color look-up table containing hypothesis decision output information. The multi-dimensional color look-up table of FIG. 3 is a three dimensional lookup table 292, and is represented schematically using orthogonal R, G, and B axes. Table 292 contains cells 294 defined by (R,G,B) coordinates or tristimulus values. For example, cell 293 of table 292 is located at (Rₐ,G_{b},B_{c}), and contains hypothesis decision output information, as does all of the other (R,G,B) cells of table 293.

The multidimensional look-up tables 290 are communicated to the computer 200 and used in the analysis of an image(s), as will now be described. Referring again to FIG. 1, in a set of steps 130, the color image is provided and processed in preparation for image analysis. In step 132, a color image or a plurality of images, which depicts subject matter of particular interest and/or relevant to solving a given problem, is provided. In circumstances where more than one image is provided, the images may be multiple still images or a chronological sequence of captured images such as from a video or movie. The color image(s) is/are comprised of image pixels comprising image pixel data. In step 134, the images are processed by the computer 202 according to an executable program including algorithm 224. The image(s) may optionally be sectioned into regions of selectable and adaptable size and shape. The size and shape of the images, as well as iterations of sectioning into different sizes and shapes are chosen based on the problem being addressed and on characteristics of the image(s) to be analyzed. This will be illustrated by way of the EXAMPLES, which are described subsequently in this specification.

Certain image analysis steps 140 are then performed. Prior to these analysis steps, as described previously, in step 124 hypothesis decision output information is stored in multi-dimensional color look-up tables 290. The tables 290 are uploaded into the computer readable non-transitory storage medium 230 and/or the memory 222 of the computer 202. Alternatively, “empty” multidimensional look-up tables are provided in the computer readable storage medium 230 and/or the memory 222, and hypothesis decision output information is uploaded into the empty tables to provide the hypothesis decision output information for use in analysis of the image(s).

In step 142, the computer 202 executes an algorithm 224 to analyze the image(s) using the multi-dimensional color look-up tables 290. Logic decision output information is produced for each pixel in the image. The logic decision output information may be the probability of an event occurring if that particular color value is present. In step 144, the logic decision output information is grouped to produce overall logic decision output information. If the image has been sectioned into regions, the logic decision output information may be provided for each region. The algorithm contains instructions to determine an overall probability of an event occurring, based at least in part on the individual pixels and their respective probabilities of the event occurring.

In step 150, decisions are generated resulting from the analysis of the image(s). More specifically, in certain embodiments, the computer 202 continues to execute algorithm 224, by which logic decision output information from multiple regions that was produced in step 144 is combined into statistical hypothesis decisions for the color image. The statistical hypothesis decision may be a conclusion that an event has occurred, or that a threshold probability that an event has occurred has been reached. (Statistical hypothesis decisions resulting from analyses of images pertaining to certain problems are provide subsequently in the EXAMPLES provided herein.)

In certain embodiments, the statistical hypothesis decisions may be presented on a display 250 for observation and study by a human. The presented statistical hypothesis decisions may then enable the human to arrive at a practical decision or reach a conclusion, such as the exemplary decisions/conclusions shown in column 4 of TABLE 1. In certain embodiments, images may be presented to a human, which show the affirmative probability of a particular hypothesis test in each image or video frame region for further analysis by the human. Additionally, summary hypothesis test information may be presented for all images or frames regions to the human for further analysis. In other embodiments, human users may be presented with a set of hypothesis tests for which they are interested in getting automated vision decisions, and may choose one or more of the hypothesis tests.

In other embodiments, the computer 200 may further include an executable algorithm to translate the statistical hypothesis decisions of step 150 into decisions or conclusions as shown in TABLE 1.

Alternatively, in certain embodiments, in step 160, the statistical hypothesis decisions may be applied to perform an action on or relating to the subject matter of the image. The action may be taken to solve the particular problem, or the action may be taken in view of an opportunity that results from the problem being present. In certain embodiments, the computer 200 may further include an executable algorithm to translate the statistical hypothesis decisions into the action to be taken to solve the particular problem, or to react to the opportunity resulting from the problem. In certain embodiments, the instructions on the action to be taken may be communicated to a second external computer 260, which executes instructions to perform and control the action, and which is in communication with external device(s) 270 that perform the action. In other embodiments, the computer 200 may be in communication with the external devices 270, and may further include an executable algorithm to perform the desired action, or to automatically perform some part of the action. Examples of actions that may be taken to address or react to certain problems are provided in column 5 of TABLE 1.

The method 100 may further include revising the hypothesis decisions for the image(s) using an image capture specific parameter. The image capture specific parameter may be selected from, but not limited to resolution, angle, and zoom. Combinations of these and other parameters may also be used. The method 100 may further include storing a record of the hypothesis decisions. Such record may be stored in the memory 220 or storage medium 230 of the computer, or externally from the computer 202.

In certain embodiments, the multi-dimensional look-up tables 222 may be defined using a non-RGB color space that includes a transformation to a visual color space. The transformation may better define visual color differentiation of the color image(s) to be analyzed. The visual color space may be a CIE IPT color space, such as is disclosed by Ebner and Fairchild in “Development and Testing of a Color Space (IPT) with Improved Hue Uniformity,” IS&T/SID Sixth Color Imaging Conference: Color Science, Systems, and Applications, November 1998, pp. 8-13, ISBN/ISSN: 0-89208-213-5. The visual color space may be the CIECAM02 color space, as disclosed by Moroney et al. in “The CIECAM02 Color Appearance Model,” IS&T/SID Tenth Color Imaging Conference. November 2002, ISBN 0-89208-241-0; and the page, “CIECAM02” in Wikipedia at http://en.wikipedia.org/wiki/CIECAM02.

It is noted in particular that with regard to the visual color space CIE IPT, it is the only known color space that accurately measures visual color response for all colors. It is also the only color space where the luminance, I, is independent of color, and the color saturation, PT magnitude, is independent of luminance. Changes in IPT three dimensional volume throughout the IPT color space are equal to visual difference changes, so that advantageously, including this color space inside the multi-dimensional color decision tables produces results that are equivalent to visual discrimination in human vision. In contrast, this is not true for any other color space that is currently used for visual analysis modeling including but not limited to, RGB, XYZ, CieLab, CieLuv, and HSV.

Alternatively or additionally, the logic decision output information produced from the multi-dimensional look-up tables 222 may be defined using unprocessed data from digital sensors (not shown), and/or image data from multiple images captured at different exposure levels, and/or image data from multiple frames of video sequences. The logic decision output information may be further defined using joint hypothesis decisions from the video sequences, as will be illustrated subsequently in the EXAMPLES. Advantageously, by using multiple images captured at different exposure levels, the dynamic range of the image pixel data of the color image is provided with extended intensity.

In certain embodiments, the multi-dimensional look-up tables may be nested multi-dimensional look-up tables. For example, referring to FIG. 3, and in the three-dimensional look-up table 292 depicted therein, the cells 294 of such table including cell 293 may contain the addresses to the data in other multidimensional look-up tables. The nested multi-dimensional look-up tables may use high speed graphics shader processing to produce the hypothesis decisions at the high processing speeds. The nested, multi-dimensional look-up tables and hypothesis decisions may be defined using raw digital camera data. In such an embodiment, no color or range processing is needed, as is the case for current displays.

The nested, multi-dimensional look-up tables and hypothesis decision output information of steps 120 may be defined using multiple images captured at different exposure levels. In such embodiments, advantageously, the highest dynamic range of capture data for the most accurate hypothesis decisions is achieved. The images may be multiple still images or a chronological sequence of captured images such as from a video or movie. In certain embodiments, the nested multi-dimensional tables may be implemented in mobile devices, such as “smart phones” or tablet computers that include cameras for digital image or video capture. In that manner, complete image capture and analysis capabilities are provided on such mobile devices, thereby enabling generation of hypothesis decisions on such mobile devices in applications of method 100.

In certain embodiments, the nested, multi-dimensional tables may be implemented in standard graphics processor shader functions, which are look-up-tables with interpolation. This inventive use of shader tables for making analytical decisions provides significant speed advantages over other methods, such as neural networks and statistical logic that are used currently.

In certain embodiments, the method 100 may further comprise communicating a summary of hypothesis decisions to a human user using at least one of a visual display 250, an audible signal such as from speaker 252, and/or a tactile stimulator such as vibrating element 254. The hypothesis decisions for each region of the image may be communicated visually to the display 250 for further human analysis. In certain embodiments, a subset of the hypothesis decisions of step 150 may be chosen for vision decision training of a human user. In such embodiments, at least one of the chosen hypothesis decisions may be chosen by human users and automatically analyzed. Such analysis may be performed by computer 202, or by another computer (not shown).

The instant method is not limited to use in analyzing a single color image. In certain applications, the subject matter of particular interest and/or the given problem to be solved are comprised of or addressed using multiple images. In such circumstances, the method further comprises providing a plurality of color images, each of the images depicting subject matter pertaining to the problem of interest and comprised of image pixels comprising image pixel data; sectioning the color images into regions of selectable and adaptable size and shape; for each pixel in each of the color images, using the multi-dimensional color look-up tables 222 to produce logic output information; and applying the hypothesis decisions to perform the action on the subject matter of the images directed to produce a decision regarding the problem of interest. The plurality of color images may be comprised of multiple still images, or a chronological sequence of captured images, such as from a video or a movie.

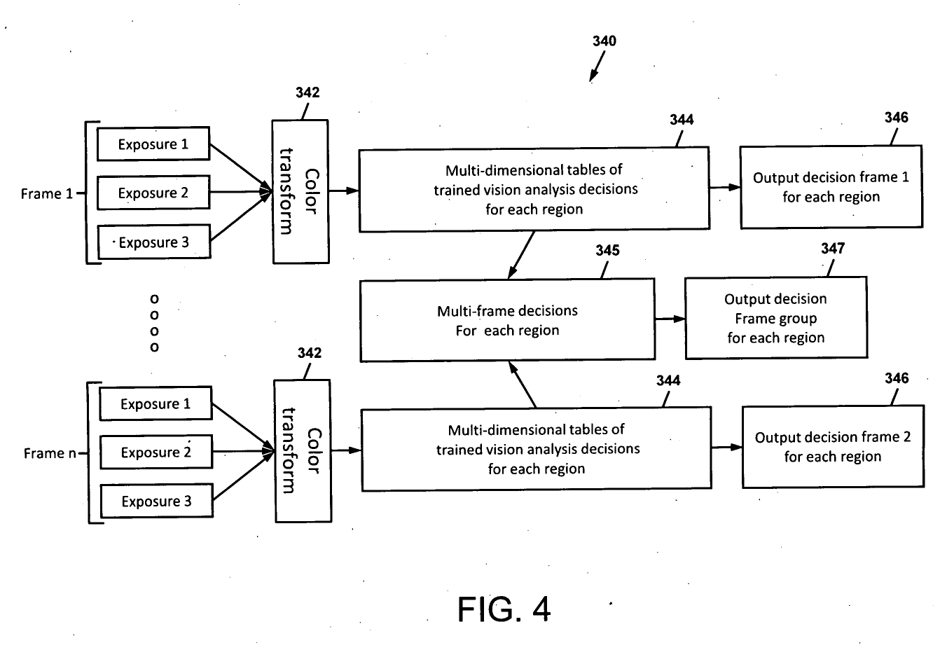

FIG. 4 is a block diagram of image analysis steps 340 that may be performed using the multi-dimensional color look-up tables 222 to produce logic decision output information. The steps 340 may be considered to be a specialized version of the steps 140 of the method 100 of FIG. 2, when a sequence of multiple images is to be analyzed, such as a sequence of video images. The video images are comprised of multiple image frames, each with different exposure levels.

An exemplary video being analyzed according to the steps 340 of FIG. 4 is comprised of n frames of images. In certain embodiments, each frame may also be produced at different exposure levels, i.e., Exposure 1, Exposure 2, and Exposure 3. In this aspect of the present invention, multiple still or video cameras are used to captures image scenes at different exposure levels, in order to model the full adaptive dynamic range of vision. This practice enables more detail in shadows and highlights of images and videos to be used in the hypothesis decision process. Additionally, these additional exposure level images or videos can be added into the multi-dimensional table nested sequence to provide additional input information in each image or video region to improve hypothesis decisions. (Essentially, this aspect of the invention models how human vision can peer into shadows and adjust its response to see more detail for better analysis, which is a major advantage of vision in all of the applications of this invention. In contrast, current methods of image or video analysis do not use these multiple exposure images and are limited by the ability of the digital camera dynamic range, which is significantly less than that of human vision.)

In step 342, each frame, and each exposure if applicable, may undergo a color transformation. The color transformation 342 may be a transformation from an RGB color space to a visual color space, such as CIE IPT color space or the CIECam02 color space as described previously. Prior to, or subsequent to the color transformation 342, each of the frames of video images 1 through n may be sectioned into regions, as described previously as step 134 of method 100. In step 344, the respective multi-dimensional tables 222 for frames 1-n are applied to logic decision output information for each region to produce logic decision output information for each of frames 1-n. The logic decision output information may be trained vision analysis decisions as indicated in FIG. 4.

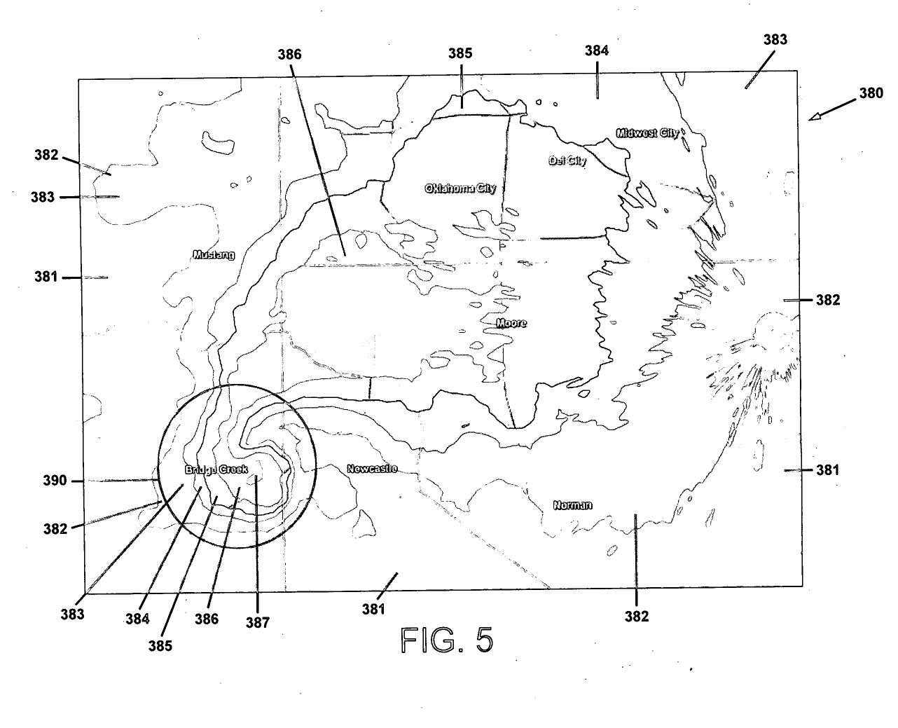

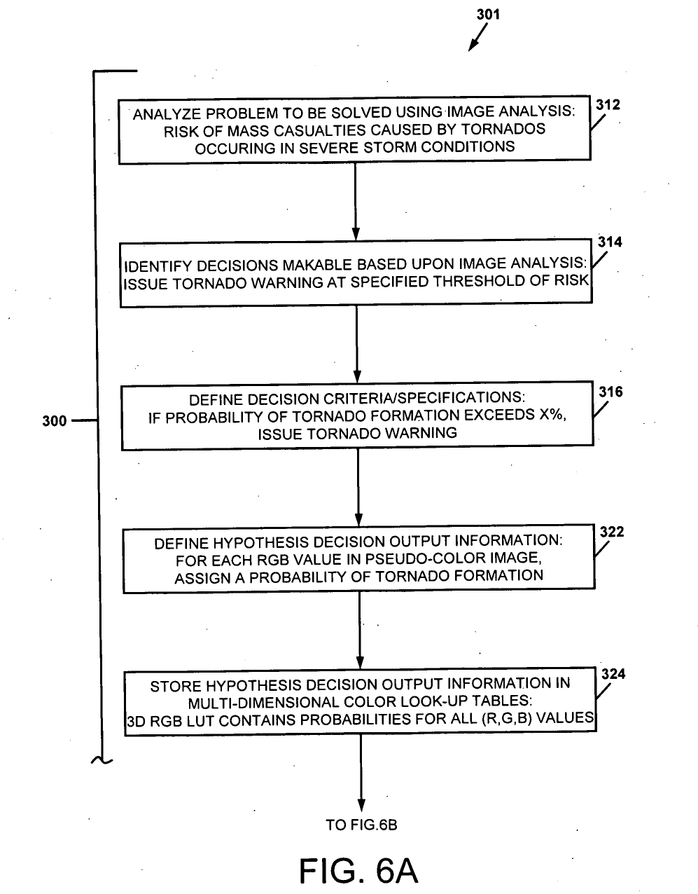

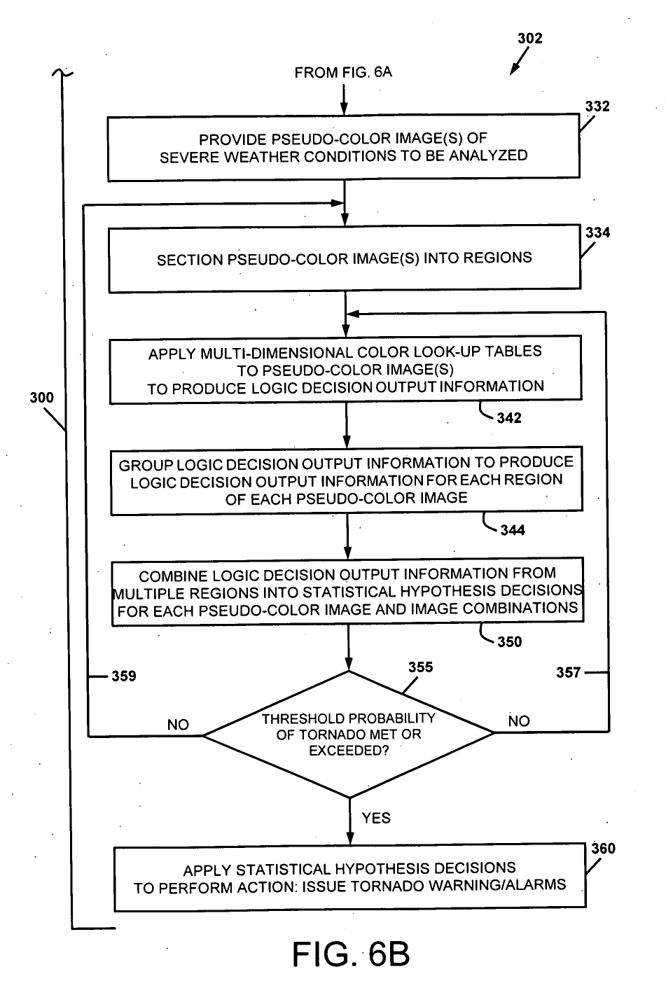

In embodiments in which the frames are produced at different exposure levels, each exposure is analyzed individually to produce logic decision output information, which is then combined into a decision for that frame. Subsequently, the decisions for the individual frames are used to produce joint logic decision output information, i.e. a joint final decision for the entire sequence of images in the video. For example, in the analysis of a weather event (as is described subsequently herein with reference to FIGS. 5-6B), if the decision from a first frame is a low probability of tornado, a decision from a second frame is a medium probability of tornado, and the decision of a third frame is high probability of tornado, the final decision would be based on the third frame, i.e. a high probability of tornado, because any indication of a high probability would be the basis to issue an alarm.

In step 346, output decisions may be issued for each region of each of the respective frames 1-n. Additionally, in step 345, the logic decision output information may be combined to provide multi-frame decisions for each region, and an overall output decision for each region of a frame group may be issued in step 347. In certain embodiments, the multi-dimensional look up tables 222 may be applied to visual color transformed, raw digital camera data for each frame using multiple exposures or for a group of frames using decisions for each region from multiple frames.

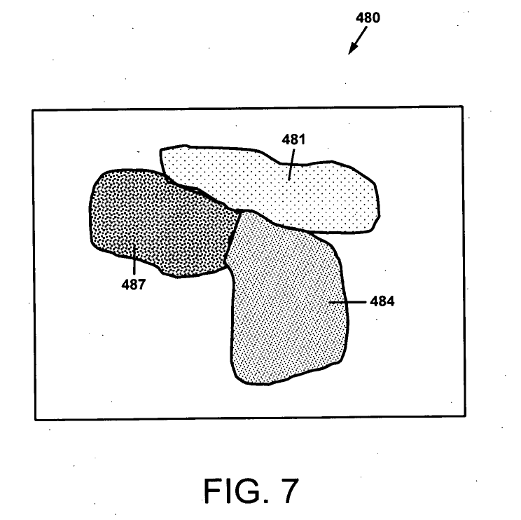

In certain embodiments, the multi-dimensional color look-up tables 222 may include color input from every pixel in a still frame image or video. In that manner, billions of color data points may be processed to enable real time output of hypothesis decisions, and subsequent action(s) on or pertaining to the problem of interest. The multi-dimensional color look-up tables 222 may also be nested in a configuration that enables construction of decision diagrams that build final decisions for regions of image and video data using statistical training and hypothesis testing. It is noted that in defining the regions in the image frames, the regions may overlap to some extent (as is presented subsequently in Example 2 with reference to FIGS. 7-10).

In one aspect of the methods of the present invention, a key action in defining the multi-dimensional tables 222 of FIG. 2 per step 124 of FIG. 1 is to “train” the multi-dimensional tables 222 to perform the statistical hypothesis tests so that each pixel input from a single image or video provides a statistical decision for the specific analysis. Using human visual judgments, this training can be done automatically from the input color data. As used herein, training a table means using human analysis of regions of sample images that are representative of imaged that will be analyzed using the method, and loading those values into the multi-dimensional table with the image values as inputs. For example, in the analysis of images that are indicative of a weather event as described subsequently with reference to FIGS. 5-6B, an image value (in R,G,B) of (255,0,0) (i.e., a saturated red) could be assigned as indicating a 100% probability of tornado. This value, and other colors indicative of a lesser probability of tornado are loaded in the multi-dimensional table. The significant number of full resolution pixels in images and videos may then be used to reduce hypothesis errors due to optical limitations, fatigue, and observer variations.

In practice, for human decision analysis from images, the volume of data using individual pixels requires significant optical zooming and roaming in typical observer analyses, which is costly and time consuming. In contrast, using trained, nested multi-dimensional color tables as described herein, these analyses can be of significantly lower cost and faster, thereby enabling more images and videos to be analyzed, thus improving the overall analytical decision making.

In another aspect of the present invention, the visual analytical decision making methods may be implemented on a mobile device, such as a smart phone or tablet computer, that includes a digital camera. This enables the multi-dimensional tables to use raw digital camera data to significantly improve the analytical accuracy of the end results. The reason for this is that the raw digital camera data includes much larger color and range data than processed digital camera data. Current digital camera color and range processing is performed taking into account the limitations of current LCD displays (or other alternative displays); as a result, a very large portion (in some instances over 90%) of the actual scene differences in an image may be lost.

An example, it is noted that digital cameras record uniquely different values for green lasers and green grass, but the image processing that is embedded in most digital cameras removes those differences from the data, and produces the same display values for these dramatically different values of green. In making analytical decision using the methods of the present invention, particularly in military and intelligence applications, it is important to maintain those differences, in order to provide the best decisions. In embodiments of the present invention, those differences are maintained by using the raw digital camera data directly in the multi-dimensional tables so different decisions can be produced by those tables. This is substantially similar to having visual analysis capabilities at a scene, because human vision can clearly see, for example, the difference between green lasers and green grass. Accordingly, this aspect of the present invention significantly improves the visual decision modeling by maintaining full visual data throughout the image processing.

In another aspect of the invention, data on the likelihood of a particular hypothesis test result may be outputted by the computer 202 of FIG. 2. For example, in an oil exploration image, an output may be that there is a 90% probability of oil being a particular geologic formation. (Additionally test data may be color coded into a color image using the pseudo-colors, thereby enabling the identification of locations of interest (“hot spots”), such as locations of an oil exploration image that are likely to contain oil. A particular color associated with a high probability of oil being present is more effective in commanding the attention of a human observer of the image. In certain embodiments, a pseudo-color algorithm uses colors that intuitively give the most visual clues, i.e., attract the most attention of a human observing the pseudo color image. For example, red may be associated with high probability, and blue may be associated with low probability.

In certain embodiments in which the color image(s) to be analyzed are transformed into the visual CIE IPT color space, the visual color space IPT is “cut” into pie wedge sectors and moved around with respect to the most visible colors as perceived by a human. For example, a bright saturated yellow may transition to an opponent color such as dark desaturated blue as the hypothesis value changes. In that manner, a human observer perceives large isomap contours of hypothesis probabilities as he navigates through probability numerical results provided by the computer 202.

### EXAMPLES

The methods and systems of the present disclosure will now be further described and illustrated by way of several examples. It is to be understood that the following examples are not to be considered as limiting the instant methods and systems to use only with these examples. There are many other applications and uses that are within the scope of the present disclosure, including but not limited to applications cited in TABLE 1, pertaining to agriculture, energy, space exploration, oceanographic exploration, seismology, military, homeland security, and law enforcement operations, consumer products, and object authentication.

### Example 1

A first example is now described with reference to FIGS. 5-6B. The example is directed to a method of reducing risk due to a weather event. Referring first to FIG. 6A, which is a flowchart depicting a first portion 301 of the method 300, in step 312, a problem that may be solved or addressed in some way using image analysis is identified. The problem to be addressed in this example is that given the risk of mass casualties due to the formation of a tornado, which may occur during severe storm conditions, how a timely warning of tornado formation can be provided so that people can seek appropriate shelter.

In the ongoing tracking of weather conditions, and particularly during storm conditions, a variety of color images are generated that represent various weather conditions, such as wind speed and/or velocity, air density, precipitation rate, barometric pressure, and air temperature. In such color images, a range of values of a particular parameter such as wind speed is represented by a range of colors (referred to herein as pseudo-colors). The pseudo-colors may be quantitatively defined by tristimulus color values, such as RGB (R,G,B) values.

FIG. 5 is a grey scale version of an exemplary pseudo-color image 380 of a severe weather event. (The image is sourced from the National Weather Service, and depicts a severe storm, which occurred on May 3, 1999, and which spawned numerous tornados.) The color image 380, and other similar color images may be comprised of various pseudo-color regions. For example, color image 380 is comprised of a background color region 381, and color regions 382-387. The background color region 381 indicates a region where the parameter represented by the pseudo-colors is zero, or is negligible; in image 380, the background color region indicates an area of zero or near-zero wind velocity. Color regions 382-387 are regions of ranges of wind speed from a lowest range 382 to a highest range 387. Typically, each color regions is of a different hue; for example, regions 382-387 are presented in hues of violet, blue, green, yellow-orange, red, and magenta, respectively. Within each region, in certain images, the brightness of the particular color may be varied, with higher brightness areas indicating lower wind speed values within the range, and lower brightness (darker) areas indicating higher wind speed values within the range. Alternatively, the pseudo-colors may be provided over a larger number of hues, each hue being of a smaller range. The exact manner in which the pseudo-colors are defined to represent the range of possible values of the particular parameter of interest may vary, as long as the variation of pseudo-colors as a function of the parameter is well defined and is understood, so that the methods of the present disclosure can be practiced.

Referring again to FIG. 6A, the various types of color images that can provide information relevant to the problem if interest are analyzed. In this example, the color images may include pseudo-color image 380 that represents values of wind speed, as well as other pseudo-color images (not shown) that provide data on other weather parameters including but not limited to wind velocity, air density, precipitation rate, barometric pressure, and air temperature. In step 314, a decision or decisions are identified which may be made based upon an analysis of the color image(s). In this example, one decision that may be made is to issue a tornado warning when the analysis of the image(s) determines that a specified threshold of tornado risk has been reached.

In step 316, the decision criteria are defined; in this example, one decision could be to issue a tornado warning if the probability of tornado formation, as determined by the analysis of the relevant images, exceeds X %. For any given problem to be addressed, the value of X is dependent upon the particular problem, and the consequences of a Type I or a Type II error occurring. In this example, a Type I error would be incorrectly concluding that a tornado has formed when none is present, and a Type II error would be incorrectly concluding that a tornado is not present when one is present. Given that the consequences of issuing a tornado warning when none is present, and causing people to needlessly rush to protective shelter are more preferable than not issuing a tornado when one is present, and having people not take protective shelter and risk loss of life, in this example, the value of X may be chosen to be relatively low (as compared to values used in addressing other problems), so that the likelihood of a Type II error is low compared to that of a Type I error. In other words, it is preferable to choose X such that some “false alarms” may be issued, rather than failing to issue a correct alarm when it is critically needed.

In step 322, hypothesis decision output information is defined for each value in a color image. If the pixels of the digital color image are represented by RGB tristimulus values, then for each (R,G,B) value, a probability of tornado formation is assigned. (The probability may be defined on a 0-100% scale, or a 0-1.00 scale, 100% and 1.00 being complete certainty.) In the exemplary pseudo-color image 380 of FIG. 5, the colors are indicative of wind speeds. Accordingly, the probability of a tornado being present can be estimated as a function of wind speed by analysis of historical data of severe weather events that spawned tornados. Such data may be obtained from sources such as government agencies (National Weather Service, National Oceanic and Atmospheric Administration), university researchers, and from meteorology departments at television broadcast stations. Additionally mathematical models, published primarily by government and university researchers, may also be consulted in estimating tornado formation probabilities.

In general, such an analysis and estimation of probabilities will result in pseudo-colors regions that are associated with low ranges of wind speed, such as regions 382 and 383 having probabilities of tornado formation that are very low, even at or near zero, and pseudo-color regions that are associated with the highest ranges of wind speed, such as regions 386 and 387, having probabilities that are significantly higher.

In step 324, the hypothesis decision output information, i.e., the respective probabilities of tornado formation defined in step 322 for all of the (R,G,B) pseudo-color values are stored in a color look-up table. In this example, since the pseudo-colors are represented by RGB tristimulus values, the lookup table is a three-dimensional lookup table, such as table 292 of FIG. 3. For example, cell 293 of table 292 is located at (Rₐ,G_{b},B_{c}), and contains a tornado formation probability for that pseudo-color, as does all of the other (R,G,B) cells of table 292. For regions of colors that represent high wind velocities, such as red and magenta regions 386 and 387, respectively, the probabilities will be relatively high, and for regions of colors that represent low wind velocities, such as violet and blue regions 382 and 383, respectively, the probabilities will be low.

Referring also to FIG. 2, the lookup table 292 is communicated to computer 202. The lookup table 292 may be stored in the storage medium 230 and/or the memory 220 of computer 202.

Referring now to FIG. 6B, which depicts a second portion 302 of the method 300, and to FIG. 2, a pseudo-color image or images are provided to the computer 202 from an input data source 280. The input data source 280 may be a Doppler radar device, which measures wind speed as a function of location, including GPS coordinates and elevation, and which includes an algorithm to represent wind speeds by pseudo-colors, mapped by location. Alternatively or additionally, other input data sources may provide pseudo-color images, the colors of which represent values or ranges of parameters such as wind direction, air density, precipitation rate, barometric pressure, and air temperature.

In step 334, the pseudo-color image, such as image 380 of FIG. 5, may be sectioned or subdivided into regions. The sectioning of the image may be done by an algorithm executed by the computer 202. In one embodiment (not shown), the sectioning may be done by subdividing the image into a grid of rectangles or other regular geometric shapes. In another embodiment, the sectioning of the image may be done by subdividing the image according to the pseudo-color regions of the image, such as regions 382-387 of image 380. In yet another embodiment, the image may be analyzed according to an algorithm executed by the computer 202 in which a particular color pattern is sought. For example, in image 380, an algorithm may be executed by the computer 202, in which region 390 is identified for a particular analysis, as will be described subsequently.

In step 342, the three-dimensional lookup table 292 is used to produce logic decision output information. In this example, each pixel of the pseudo-color image 380 is defined by an RGB tristimulus value. Accordingly, the logic decision output information is a probability of tornado formation assigned to each pixel of the pseudo-color image 380.

In step 350, the logic decision output information, i.e., the combination of probabilities of tornado formation assigned to the pixels of the pseudo-color image 380 is analyzed in toto. Per a pre-defined algorithm, which may be an algorithm 224 executed by the computer 202, a statistical hypothesis decision is produced. In this example, the statistical hypothesis decision is the determination of an overall probability of tornado formation based on the analysis of the pseudo-color image 380.

At logic gate 355, the question as to whether the probability of tornado formation has met or exceeded a predetermined threshold. If YES, then the statistical hypothesis decision is applied to perform an action in step 360, which in this example is to issue tornado warnings and/or alarms. Such warnings may be issued through various communication media, such as broadcast radio and television, cell phones, screen displays in automobiles, and the like; as well as visible and audible alarms distributed throughout the region. If NO, then the method 300 may continue via loops 357 or 359, as will be described subsequently.

As described previously, the pseudo-color image being analyzed may be sectioned or subdivided into regions. If the image is sectioned into regions, then method 300 may include step 344, in which the logic decision output information is grouped to produce logic decision output information for each region. Subsequently, in step 350, the logic decision output information, i.e. the probabilities of tornado formation for the pixels of individual regions and/or combinations of regions may be analyzed according to algorithms to provide the statistical hypothesis decision.

In certain embodiments, combinations of multidimensional color lookup tables may be used to produce a statistical hypothesis decision. In certain embodiments, a statistical hypothesis decision is produced from the application of each color lookup table, and then an overall joint hypothesis decision is produced from the individual statistical hypothesis decisions.

In other embodiments, the lookup tables may be nested. By way of illustration using the present example, multiple multidimensional lookup tables may be provided, such as a first table described previously that maps pseudo-colors to wind speeds, a second table that maps pseudo-colors to wind direction, and a third table that maps pseudo-colors to barometric pressure. An additional nested multidimensional lookup table is provided which, for each color value, contains logic decision output information that is based upon the combination of logic decision output information of the three tables. The logic decision output information is the probability of tornado formation for that color value, which the algorithm determines based upon the combination of the probabilities for that color value in the first, second, and third multidimensional lookup tables.

In certain embodiments, the sectioning of an image that is being analyzed may be made selectable and/or adaptable. For example, if a first analysis of an image, such as image 380, indicates that the probability of tornado formation has not reached the predetermined threshold for taking an action as in step 360, then the algorithm for analysis of the image may contain instructions to section the image into a different array of regions. In such an embodiment, loop 359 is executed, and the analysis of the differently sectioned image 380 proceeds. The computer 202 is provided with sufficient processing capacity and speed so as to perform repeated iterations of sectioning and image analysis of the image 380 in real time.

In certain embodiments, the analysis of the image 380 may include the application of multidimensional interpolation. Such interpolation may be performed using graphics shader processing, which may be as disclosed in Graphics Shaders Theory and Practice, 2^{nd} Ed., Bailey et al., CRC Press, 2012, the disclosure of which is incorporated herein by reference.

In other embodiments, a sequence of multiple images may be analyzed, such as a chronological sequence of images from a video. In such embodiments, a first image may be analyzed, resulting in the statistical hypothesis decision that that the probability of tornado formation has not reached the predetermined threshold for taking an action as in step 360; subsequently, loop 357 or 359 is executed, with optional image sectioning and the multidimensional lookup table(s) being applied to the second image in the sequence in steps 334, 342, 344, and 350. Loops 357 or 359 may continue to be applied to subsequent images in the sequence, with repeated checks 355 as to whether the probability of tornado formation has met or exceeded a predetermined threshold.

In a further embodiment, the image analysis algorithm 224 may contain instructions to analyze the degree of change in the pseudo-colors over a sequence of two or more images of a video. The logic of the algorithm is based on knowledge that the time dependent rate of change of wind speeds (as represented by the pseudo-colors) can also be indicative of a high probability of tornado formation. Thus a joint hypothesis decision may be produced based on the analysis of the sequence of images.

In yet another embodiment, the image analysis algorithm 224 may contain instructions to analyze the spatial gradient in the pseudo-colors in an image. In this embodiment, the logic of the algorithm is based on knowledge that if there is a high spatial gradient of wind speeds (as represented by the pseudo-colors), i.e., a high degree of wind shear, this is also indicative of a high probability of tornado formation.

In particular, the algorithm 224 may contain instructions to identify a high spatial gradient of pseudo-colors that has a radial aspect. Referring to FIG. 4, the image may be sectioned into regions including region 390. The analysis of region 390 determines that, starting at the 12 o'clock position above pseudo-color region 387, there is a high color gradient across the 12 o'clock position, all the way around to the approximately 9 o'clock position. This radially sequenced pseudo-color gradient is indicative of a rotational wind flow which produces a “hook echo” on Doppler radar, and which is known to be indicative of a high probability of tornado formation.

In certain embodiments, the multi-dimensional look-up tables, such as table 292 of FIG. 3, may be defined using a non-RGB color space. The non-RGB color space may be defined using a transformation from RGB color space to a visual color space. The visual color space may be selected from, e.g., CIE IPT color space or CIECam02 color space.

### Example 2

A second example is now described with reference to FIGS. 7-10. The example is directed to a method of oil and gas exploration, and in particular, a method of identifying a candidate oil and/or gas drilling site, that has a high likelihood of becoming a profitable oil and/or gas well. Referring first to FIG. 7, an exemplary image obtained from oil and gas exploration is depicted. It is to be understood that image 480 is a simplified image provided for illustration purposes, and that other images may be used on the instant method of oil and/or gas exploration. For example, the instant method may be performed using an image obtained from reflection seismology, i.e., the image may be of a seismic reflection profile.

Referring again to FIG. 7, the simple exemplary exploration image 480 obtained from an oil/gas exploration apparatus (such as a reflection seismology apparatus), is depicted. The image 480 is comprised of three regions of color or pseudo-color 481 (depicted by low density small dots), 484(depicted by high density small dots), and 487(depicted by high density large dots). These regions of color correspond to subterranean geologic regions of different material composition, such as varieties of igneous, sedimentary, or metamorphic bedrock, or liquid magma, or pockets of fluids such as oil, gas, and/or water. Additionally, a region of color may correspond to bedrock such as shale (e.g., Marcellus shale) or sandstone that are infused with gas or oil. It will be apparent that although FIG. 7 depicts only three regions of pseudo-color 481, 484, and 487, an image to be analyzed may be comprised of many more color regions, since a given image may capture subterranean structures comprised of many more material compositions. Additionally, it is to be understood that although the pseudo-color regions 481, 484, and 487 in FIGS. are depicted as discrete regions with defined boundaries, it is to be understood that some overlap of the regions may be present. This is because the precise boundaries of the geologic formations may not be precisely defined by the imaging method and/or the geologic formations may not have distinct boundaries, i.e., there may be some blending of the formations where they intersect.

FIG. 8 depicts a first exemplary output hypothesis test % for hypothesis test T from the regions 481, 484, and 487 illustrated in FIG. 7. The first hypothesis test in FIG. 8 is, “What is the likelihood that this region contains oil?” It can be seen that the respective likelihoods are 70%, 20%, and 92% for regions 481, 484, and 487. Thus this output information would be applied to make a decision to take the action to drill oil wells in the geologic region that corresponds to the region 487 in image 480.

FIG. 9 depicts a second exemplary output hypothesis test % for hypothesis test S from the regions 481, 484, and 487 illustrated in FIG. 7. The second hypothesis test in FIG. 9 is, “What is the likelihood that this region contains shale?” It can be seen that the respective likelihoods are 55%, 95%, and 35% for regions 481, 484, and 487. Since it could be known that shale formations, such as Marcellus shale formations, inherently contain oil that can be extracted by the use of hydrofracturing, it may be sufficient to simply identify the rock formation as being shale. Thus this output information would be applied to make a decision to take the action to drill oil wells in the geologic region that corresponds to the region 484 in image 480, since that region is very likely to be shale and this to contain oil. (It is to be understood that this example is entirely independent of the example of FIG. 8, i.e. the geologic formations in the image 420 as referenced to FIG. 8 are not the same as the geologic formations in the image 420 as referenced to FIG. 9. In other words, the image 420 that results in the hypothesis test of FIG. 8 has different geologic formations than the image 420 that results in the hypothesis test of FIG. 8. For simplicity of illustration, image 420 of FIG. 7 is used to teach both of the principles of FIG. 8 and FIG. 9.)

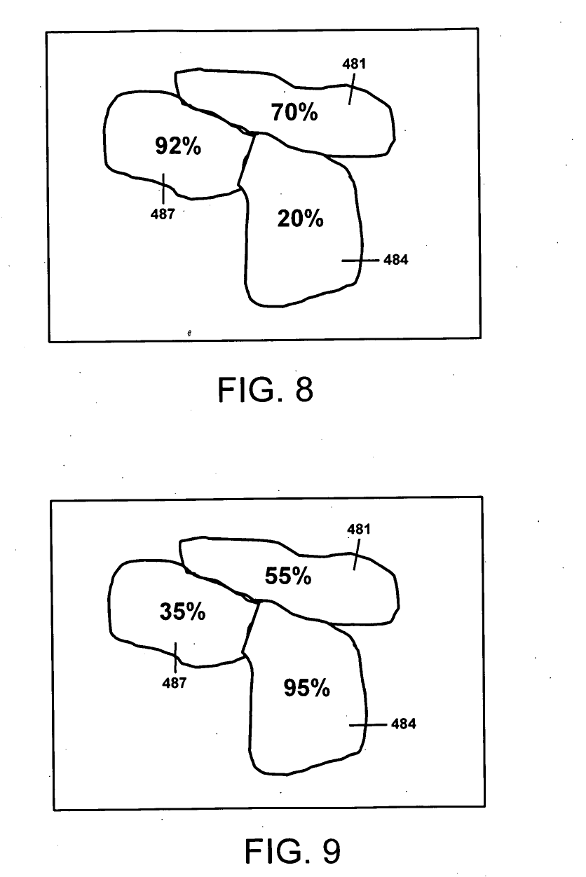

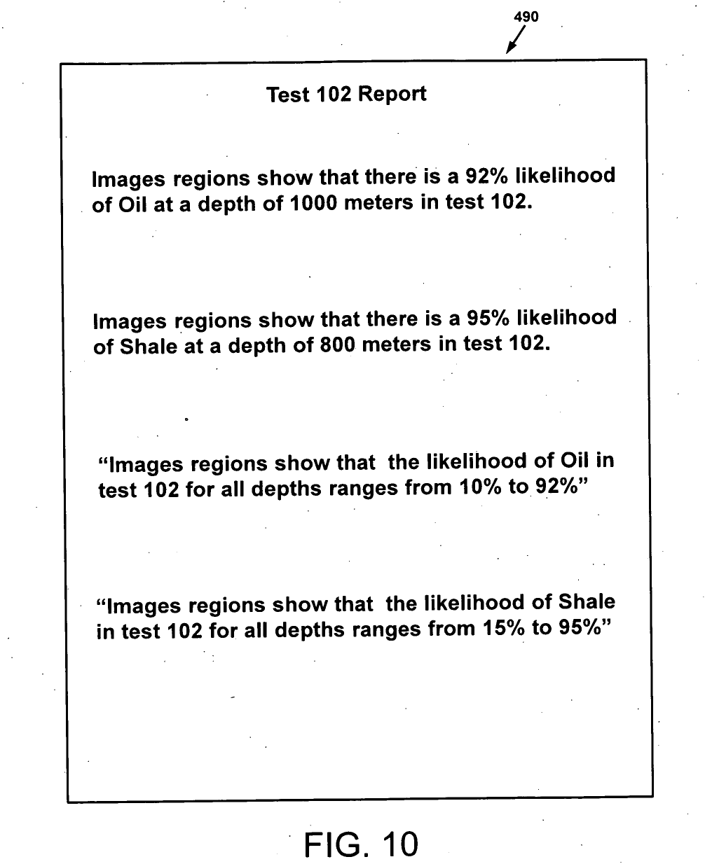

In a further embodiment, the processor 202 of system 200 may include an algorithm to analyze multiple regions in an image, or a sequence of images in a video, and perform an analysis to aggregate an overall decision about the likelihood, size, depth and type of oil or shale deposits in geologic formations that are represented in an image or sequence of images. The algorithm may output a report on a display of other medium. FIG. 10 depicts an exemplary aggregated overall decision report 490 for a test named “Test 102,” which describes the likelihood of the hypotheses tests of FIGS. 8 and 9 being true.

In a broader aspect of the present disclosure, there is provided a method of energy resource development. The method comprises acquiring a color image indicative of an energy source present in a region of the Earth, the color image comprised of image pixels comprising image pixel data; defining decision criteria, including at least one action to be taken if the probability of the energy source being present exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the energy source being present; combining logic decision output information into statistical hypothesis decisions for the color image, including determining the overall probability of the energy source being present; and if the overall probability of the energy source being present exceeds the threshold value, performing an action in advance of the energy source being developed for use in an energy application.

The instant method is applicable to (but not limited to) circumstances in which the subterranean energy source is oil, natural gas, or geothermal energy. As used herein, the term “the energy source being developed for use in an energy application” includes but is not limited to extracting the energy source from the Earth, refining the energy source, transporting the energy source, and/or converting the energy source to an alternate form of energy.

In embodiments in which the energy source is oil and/or natural gas, the method may further comprise drilling a well for extracting the oil and/or natural gas. Alternatively or additionally, the method may further comprise executing a transaction in a commodities market for the at least one of oil and natural gas. In embodiments in which the energy source is a geothermal energy source, the method may further comprise drilling a geothermal well in communication with the geothermal energy source.

The images to be analyzed may be obtained from a variety of sources, including but not limited to geophysical images (also known as geophysical tomography), two dimensional and/or three dimensional reflection seismology images, visible spectrum and infrared/thermal satellite images of the atmosphere, land, and oceans/seas of the Earth. In the analysis of images, the subject matter of the images may be any subject matter relevant to energy development, including geologic features, pipelines, refineries, rail yards, harbors, and other transportation and shipping hubs.

### Example 3

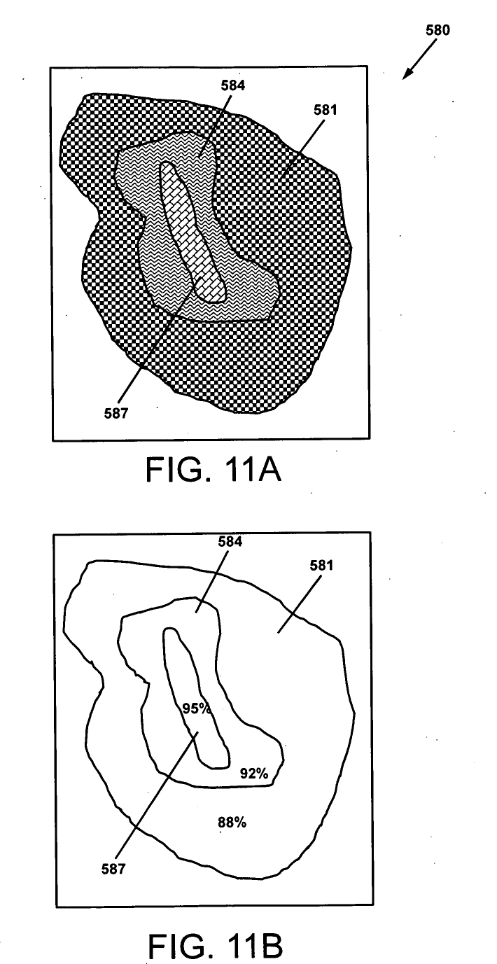

A third example is now described with reference to FIGS. 11A-11B. The example is directed to a problem in medical diagnosis, and in particular, a method of identifying a tissue region that has a high likelihood of being a tumor. Referring first to FIG. 11A, a monotone representation of an exemplary image obtained from a medical imaging apparatus is depicted. It is to be understood that image 580 is a simplified image provided for illustration purposes, and that in practice, considerably more complex images may be analyzed. For example, the images may be computerized tomography (CAT scan) images, or magnetic resonance (MRI) images.

Referring again to FIG. 11A, the simple exemplary image 580 obtained from a medical imaging apparatus is comprised of three regions of color or pseudo-color 581 (depicted by high density large dots), 584(depicted by high density wave pattern), and 587 (depicted by diagonal “brick” pattern). These regions of color correspond to regions of different tissue composition. It will be apparent that although FIG. 11A depicts only three regions of pseudo-color 581, 584, and 587, an image to be analyzed may be comprised of many more color regions, since a given image may capture anatomical regions comprised of many types of tissue.

FIG. 11B depicts a first exemplary output hypothesis test % for hypothesis test from the regions 481, 484, and 487 illustrated in FIG. 11A. The hypothesis test in FIG. 11B is, “What is the likelihood that this region is a tumor?” It can be seen that the respective likelihoods are 88%, 92%, and 95% for regions 581, 584, and 587. Thus this output information would be applied to make a decision to take a further medical action. Such an action might be obtaining further images for analysis, performing a biopsy (of region 487 in particular), exploratory surgery, or chemo or radiation therapy.

### Example 4

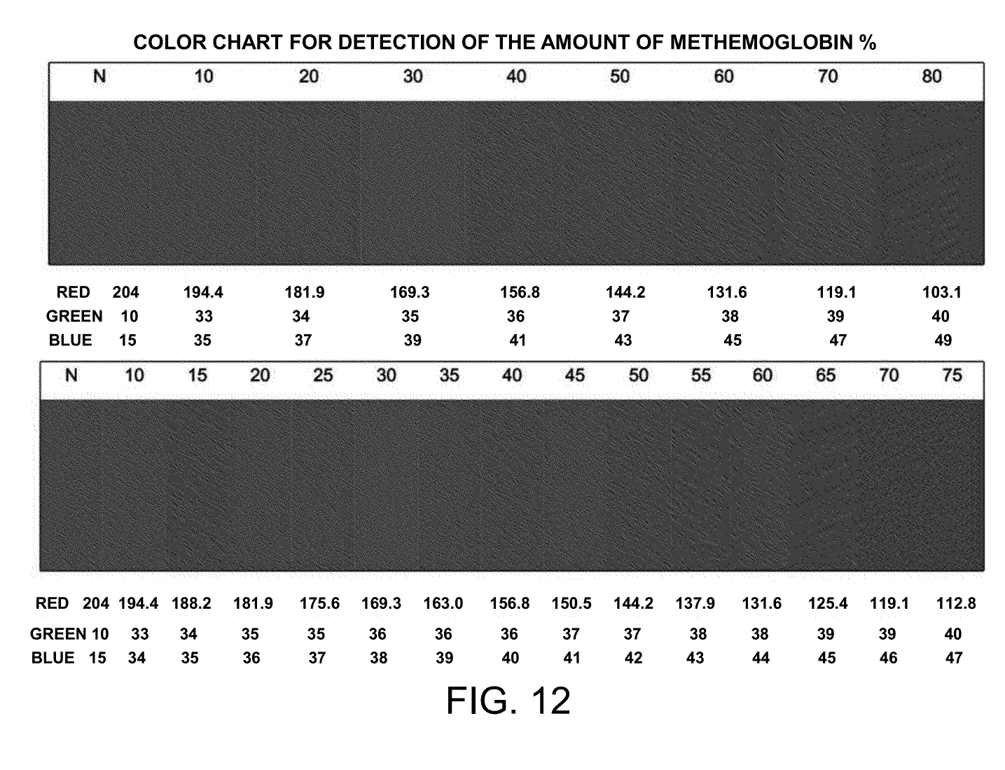

A fourth example is now described with reference to FIGS. 12-17C. This example is also directed to a medical problem. More particularly, the example is directed to a surgical method in which an endoscope or other medical imaging device is used, and in particular, a method of identifying a tissue region that has a high likelihood of being hemorrhagic. The problem to be solved is to stop bleeding from a tissue, or to identify tissue that is likely to degrade and have significant bleeding.

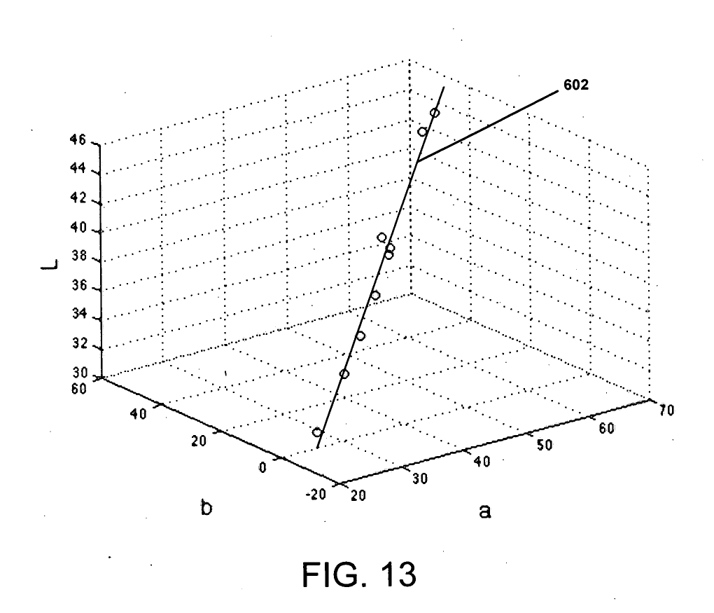

It is known that in certain circumstances, when bleeding occurs, even internally, the blood that is hemorrhaged may have a higher than normal concentration of methemoglobin. Recent research has provided a correlation between the color of in an image and the presence of methemoglobin in blood. Thus an analysis of the colors in an image according to an algorithm can indicate the presence of bleeding from tissue depicted in an image. Referring first to FIG. 12, a color chart is provided that correlates the amount of methemoglobin in blood with RGB values. The color chart is as disclosed by Shihana et al. in Ann. Emerg. Med. 2010 February; 55(2-13): 184-189. Referring also to FIG. 1, the data from this chart may be used in defining 116 decision criteria, including at least one action to be taken if the probability of bleeding by the patient exceeds a threshold value; defining 122 hypothesis decision output information for all pixel values that are possible in the color image acquired by the endoscope or other imaging device. FIG. 13 is a graph of blood color at various concentrations of methemoglobin. It can be seen that when plotted in the CieLab color space, the relationship between blood color and percent methemoglobin may be approximated by a straight line 602. In view of this relationship, and that blood that is hemorrhaged may have a higher than normal concentration of methemoglobin as stated previously, discontinuous darker red regions in an image obtained by an endoscope or other imaging device may be indicative of bleeding in a patient. Such darker red regions are discontinuous in that they have an irregular shape and/or they have sharp boundaries that contrast with lighter red, pink, white, or other colors indicative of tissue. These characteristics may be implemented in defining 116 decision criteria, including an action to be taken if the probability of bleeding by the patient exceeds a threshold value, and in defining 122 hypothesis decision output information for all pixel values that are possible in the color image.

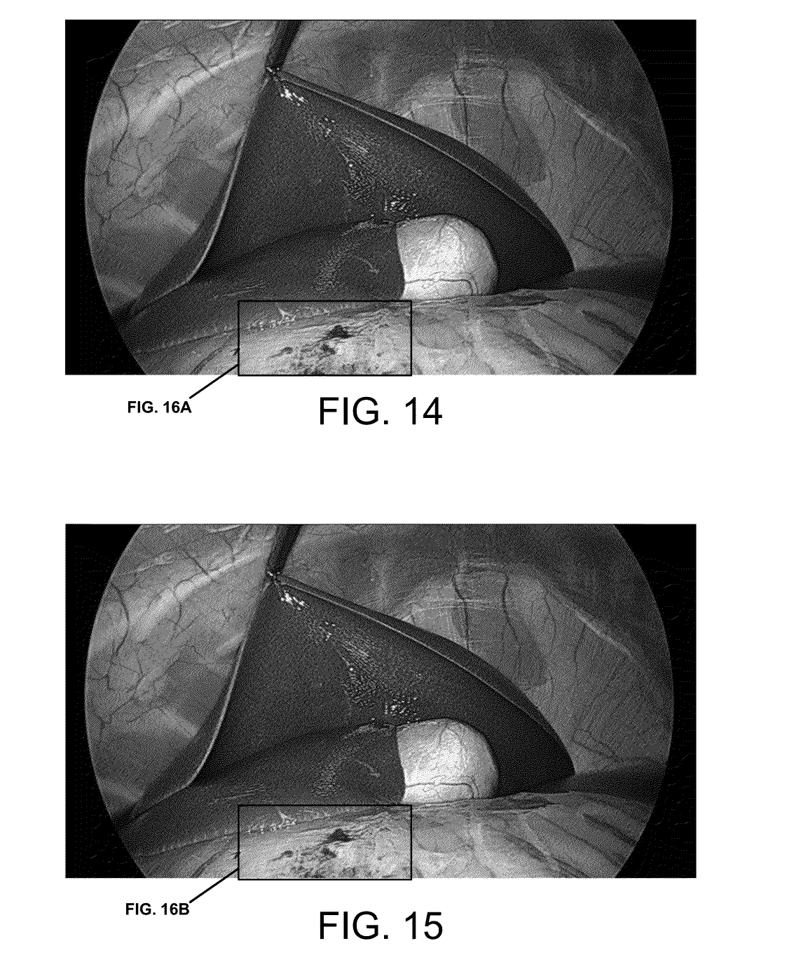

FIG. 14 is an exemplary image of internal body tissue in a patient acquired by use of an endoscope. The image of FIG. 14 may be analyzed according to the methods described previously. Additionally, prior to the analysis, or as a step in the analysis, the image of FIG. 14 may be processed according to the methods disclosed in the aforementioned U.S. Pat. Nos. 8,520,023, 8,767,006, and/or 8,860,751, to produce the image of FIG. 15 in which the colors are enhanced via the use of three-dimensional look-up tables.

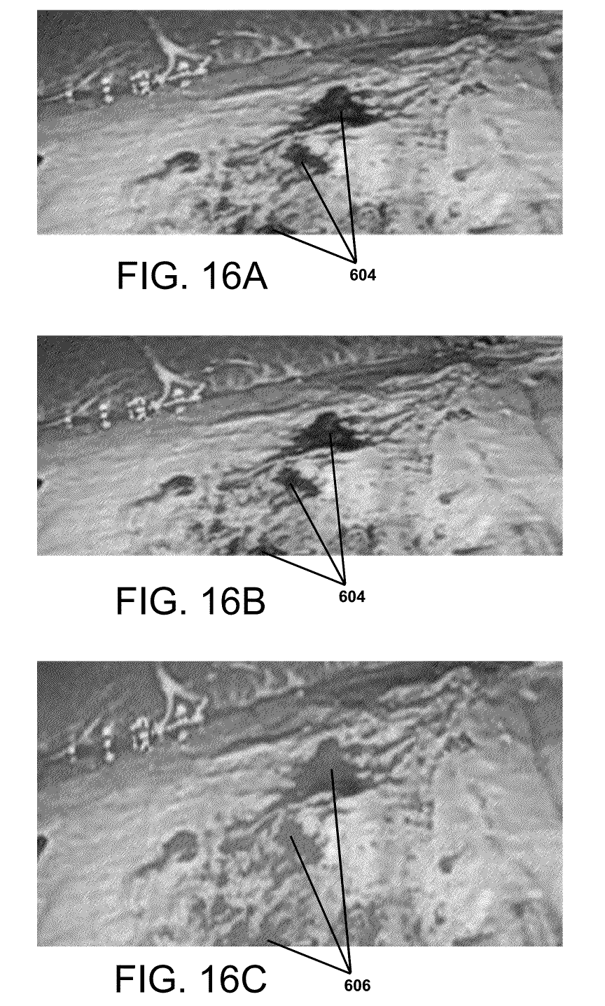

Of particular interest in FIG. 14 and FIG. 15 are the respective regions 17A and 17B, which are shown in detail in FIGS. 17A and 17B. These regions contain discontinuous dark red areas, which may be indicative of bleeding in the patient. In analyzing these regions according to the instant method, it may be determined that the probability of there being bleeding present in the patient exceeds a threshold value, and a countermeasure action by the surgeon or other medical practitioner is needed. Referring again to FIG. 2, the computer 200 may operate an audible alarm 252 or tactile alarm 254 to warn the medical practitioner, and/or render the image on display 250. The area in the image that is probable to be a hemorrhage may be marked to attract the attention of the medical practitioner. Referring to FIG. 16C, in one embodiment, the algorithm and three dimensional look-up tables may be provided such that regions 604 in the image that are of high probability of being a hemorrhage are modified to be a distinctly different color, such as green regions 606. In that manner, the medical practitioner's attention is more effectively directed to the regions of high probability of hemorrhage.

Appropriate countermeasure actions may be taken, including suturing and/or administration of an anti-clotting agent to stop the bleeding, and initiation of a blood transfusion to the patient. In embodiments in which robotic surgical tools and/or automated medication dispensing systems are used, the process control computer(s) 260 may include algorithms to take such action(s). In an alternative embodiment, the action taken may alternatively or additionally include modifying the image to provide additional information on the medical condition of the patient. Such modifying the image may include the digital filtering and/or removal of the regions in an image that are likely to be a hemorrhage or other object in the image such as bone or an implanted device, so that in effect, the hemorrhage or other object is no longer obstructing the medical practitioner's view of the underlying tissue. In that manner, a surgeon can operate on the tissue more effectively, or a radiologist or other diagnostician can more effectively diagnose a medical condition in the patient. In certain embodiments, multiple images, which may have differing spectral content, may be used in the digital filtering and/or removal of the hemorrhage regions in the image to provide a provide a clear image of the tissue obscured by the hemorrhage.

### Example 5

A fifth example is now described. The example is directed to a method of reducing risk due to a seismic event. One problem to be addressed in this example is that given the risk of mass casualties due to a seismic event such as an earthquake, tsunami, or a volcanic eruption, how a timely warning of the event can be provided so that people can evacuate the areas likely to be affected by the event.

More particularly, a method of performing an action in advance of a seismic event is provided. The method comprises acquiring a color image indicative of the seismic event, the color image comprised of image pixels comprising image pixel data; defining decision criteria, including at least one action to be taken if the probability of the seismic event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the seismic event; combining logic decision output information into statistical hypothesis decisions for the color image, including determining the overall probability of the seismic event occurring; and if the overall probability of the seismic event occurring exceeds the threshold value, performing an action in advance of the seismic event.

The images to be analyzed may be obtained from a variety of sources, including but not limited to geophysical images (also known as geophysical tomography), two dimensional and/or three dimensional reflection seismology images, visible spectrum and infrared/thermal satellite images of the atmosphere, land, and oceans/seas of the Earth.

### Example 6

A sixth example is now described. The example is directed to a method of performing an action in advance of an agricultural event. The problems to be addressed in this example are how to mitigate the effects of the agricultural event or how to take advantage of opportunities resulting from the agricultural event.

More particularly, a method of performing an action in advance of an agricultural event is provided. The method comprises acquiring a color image indicative of the agricultural event, the color image comprised of image pixels comprising image pixel data; defining decision criteria, including at least one action to be taken if the probability of the agricultural event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the agricultural event; combining logic decision output information into statistical hypothesis decisions for the color image, including determining the overall probability of the agricultural event occurring; and if the overall probability of the agricultural event occurring exceeds the threshold value, performing an action in advance of the agricultural event.

In one embodiment of the method in which the agricultural event is a low yield of a food crop in a region of the Earth, the action performed action in advance of the agricultural event includes delivering an amount of external food crop to the region of the earth to mitigate effects of the low yield of the food crop. In another embodiment of the method, in which the agricultural event is a high yield or a low yield of a commodity crop in a region of the Earth, the action performed action in advance of the agricultural event includes engaging in a transaction in a market for the commodity crop, i.e. a commodities purchase or sale, or a trade of commodities futures.

The images to be analyzed may be obtained from a variety of sources, including but not limited to visible spectrum and infrared/thermal aerial or satellite images of the atmosphere, land, and oceans/seas of the Earth. In the analysis of land-based images, the subject matter of the images may be any subject matter relevant to agriculture, including crop lands, forests, food processing factories, stockyards, rail yards, harbors, and other transportation and shipping hubs.

### Example 7

A seventh example is now described, the example directed to a problem in counterfeiting of commercial goods, documents, currency, and other objects of value; and in particular, a method of determining authenticity of an object. The method comprises acquiring a color image of the object, the color image comprised of image pixels comprising image pixel data; defining decision criteria, including at least one action to be taken if the probability of the object being counterfeit exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the object being counterfeit; combining logic decision output information into statistical hypothesis decisions for the color image, including determining the overall probability of the object being counterfeit occurring; and if the overall probability of the object being counterfeit exceeds the threshold value, confiscating the object from the object source.

The images of the object, which are to be analyzed, may be obtained from a variety of sources, including but not limited to visible spectrum images, infrared images, and ultraviolet images obtained with optical imaging devices. Alternatively, images may be obtained using non-optical methods including magnetic resonance imaging (MRI), positron emission tomography (PET), Single-photon emission computed tomography (SPECT), and computed tomography (CT) imaging.

### Example 8

An eighth example is now described, the example directed to a financial problem, and in particular, a method of performing a financial transaction in advance of an expected event. The method comprises acquiring a color image indicative of the expected event, the color image comprised of image pixels comprising image pixel data; defining decision criteria, including at least one action to be taken if the probability of the expected event exceeds a threshold value; defining hypothesis decision output information for all pixel values that are possible in the color image; storing the hypothesis decision output information in multi-dimensional color look-up tables; for each pixel of the color image, using the multi-dimensional color look-up tables to produce logic decision output information, including the probability of the expected event; combining logic decision output information into statistical hypothesis decisions for the color image, including determining the overall probability of the expected event occurring; and if the overall probability of the expected event occurring exceeds the threshold value, concluding the financial transaction in advance of the expected event.

Certain exemplary embodiments are as follows, without limitation to only these embodiments. In embodiments in which the expected event is a weather event, the financial transaction may be a transaction in a market for a commodity having a value subject to being affected by the weather event. In embodiments in which the expected event is a seismic event, the financial transaction may be a transaction in a market for a commodity having a value subject to being affected by the seismic event. In embodiments in which the expected event is a high yield or a low yield of a commodity crop, the financial transaction may be a transaction in a market for the commodity crop. In embodiments in which the expected event is discovery or development of a source of at least one of oil and natural gas, the financial transaction may be a transaction in a market for the at least one of the oil and natural gas.

It is, therefore, apparent that there has been provided, in accordance with the present invention, methods of analyzing digital color images, and making analysis-based decisions. Having thus described the basic concept of the invention, it will be rather apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims.

1. A method of performing an action in advance of an impending event, the method comprising:
a) acquiring a color image indicative of the impending event, the color image comprised of image pixels comprising image pixel data;
b) defining decision criteria, including at least one action to be taken if the probability of the impending event exceeds a threshold value;
c) defining hypothesis decision output information for all pixel values that are possible in the color image;
d) storing hypothesis decision output information in multi-dimensional color look-up tables;
e) for each pixel of the color image, using the multi-dimensional color look-up tables to produce logic decision output information, including the probability of the impending event;
f) combining logic decision output information into statistical hypothesis decisions for the color image, including determining the overall probability of the impending event occurring; and
g) if the overall probability of the event occurring exceeds the threshold value, performing an action in advance of the impending event.

2. The method of claim 1, further comprising revising the hypothesis decisions for the images using an image capture specific parameter.

3-4. (canceled)

5. The method of claim 1, wherein the multi-dimensional look-up tables are defined using a non-RGB color space that includes a transformation to a visual color space.

6. (canceled)

7. The method of claim 1, wherein the logic decision output information produced from the multi-dimensional look-up tables is defined using unprocessed data from digital sensors.

8. The method of claim 1, wherein the logic decision output information produced from the multi-dimensional look-up tables is defined using image data from multiple images captured at different exposure levels.

9. The method of claim 1, wherein the logic decision output information produced from the multi-dimensional look-up tables is defined using image data from multiple frames of video sequences including joint hypothesis decisions from the sequences.

10. The method of claim 1, wherein the multi-dimensional look-up tables are nested multi-dimensional look-up tables.

11-13. (canceled)

14. The method of claim 1, further comprising sectioning the color image into regions, grouping the logic decision output information in each image region statistically to produce logic decision output information for each image region, and combining logic decision output information from multiple regions into statistical hypothesis decisions for the color image.

15. The method of claim 14, wherein the hypothesis decisions for each region of the image are communicated visually for further human analysis.

16-19. (canceled)

20. The method of claim 1, further comprising providing a plurality of color images, each of the images depicting subject matter pertaining to the problem of interest and comprised of image pixels comprising image pixel data; for each pixel in each of the color images, using the multi-dimensional color look-up tables to produce logic output information; and applying the hypothesis decisions to perform the action in advance of the impending event.

21-22. (canceled)

23. The method of claim 20, further comprising sectioning the color images into regions of selectable and adaptable size and shape, grouping the logic decision output information in each image region of each color image statistically to produce logic decision output information for each image region, and for each color image, combining logic decision output information from multiple regions of that image into statistical hypothesis decisions for that color image.

24-32. (canceled)

33. The method of claim 1, wherein the expected event is one of a weather, seismic, political, military, economic, or medical event.

34-77. (canceled)

78. A method of treating a medical condition in a patient, the method comprising:
a) acquiring a color image indicative of the medical condition, the color image comprised of image pixels comprising image pixel data;
b) defining decision criteria, including at least one action to be taken if the probability of the medical condition being present in the patient exceeds a threshold value;
c) defining hypothesis decision output information for all pixel values that are possible in the color image;
d) storing the hypothesis decision output information in multi-dimensional color look-up tables;
e) for each pixel of the color image, using the multi-dimensional color look-up tables to produce logic decision output information, including the probability of the medical condition being present in the patient;
f) combining logic decision output information into statistical hypothesis decisions for the color image, including determining the overall probability of the medical condition being present in the patient; and
g) if the overall probability of the medical condition being present in the patient exceeds the threshold value, performing an action including at least one of preventing the medical condition being present in the patient, treating the medical condition in the patient, diagnosing the medical condition of the patient, or modifying the image to provide additional information on the medical condition of the patient.

79. The method of claim 78, further comprising sectioning the color image into regions, grouping the logic decision output information in each image region statistically to produce logic decision output information for each image region, and combining logic decision output information from multiple regions into the statistical hypothesis decisions.

80. The method of claim 78, further comprising providing a plurality of color images, each of the images indicative of the medical condition and comprised of image pixels comprising image pixel data; for each pixel in each of the color images, using the multi-dimensional color look-up tables to produce logic output information; and applying the hypothesis decisions to perform the action.

81. The method of claim 80, wherein the plurality of color images is comprised of multiple still images.

82. The method of claim 80, wherein the plurality of color images is comprised of a chronological sequence of captured images.

83. The method of claim 80, further comprising sectioning the color images into regions of selectable and adaptable size and shape, grouping the logic decision output information in each image region of each color image statistically to produce logic decision output information for each image region, and for each color image, combining logic decision output information from multiple regions of that image into statistical hypothesis decisions for that color image.

84. The method of claim 78, wherein the acquiring a color image is performed using an endoscope.

85-101. (canceled)
